(19) United States
(12) Patent Application Publication
(10) Pub. No.: US 2015/0336058 A1
(43) Pub. Date: Nov. 26, 2015

(54) NANOPOROUS FILTRATION MEMBRANES

(71) Applicant: REGENTS OF THE UNIVERSITY OF MINNESOTA, Minneapolis, MN (US)

(72) Inventors: Marc Andrew HILLMYER, Minneapolis, MN (US); Elizabeth Ashley JACKSON, Duluth, MN (US); Youngmin LEE, State College, PA (US)

(73) Assignee: REGENTS OF THE UNIVERSITY OF MINNESOTA, Minneapolis, MN (US)

(21) Appl. No.: 14/763,055

(22) PCT Filed: Jan. 27, 2014
(86) PCT No.: PCT/US14/13186

§ 371 Date: Jul. 23, 2015

Related U.S. Application Data
(60) Provisional application No. 61/758,982, filed on Jan. 31, 2013.

(51) Int. Cl. B01D 69/12; B01D 71/28; B01D 71/26; B01D 67/00; B01D 71/80

(52) U.S. Cl. CPC B01D 69/125; B01D 67/003; B01D 71/80; B01D 71/26; B01D 71/28; B01D 2323/30; B01D 2325/24

(57) ABSTRACT

Disclosed are a nanoporous membrane suitable for use in ultrafiltration comprising nanoporous cross-linked poly(styrene)-block-poly(isoprene)-block-poly(styrene) and a composite comprising the porous membrane and a microporous support. Also disclosed are methods of preparing the nanoporous membrane and the composite membrane.

### CROSS-REFERENCE TO A RELATED APPLICATION

This patent application claims the benefit of U.S. Provisional Patent Application No. 61/758,982, filed Jan. 31, 2013, the disclosure of which is incorporated by reference.

### STATEMENT REGARDING FEDERALLY SPONSORED RESEARCH AND DEVELOPMENT

This invention was made with Government support under Grant Number DMR-1006370 awarded by the National Science Foundation. The Government has certain rights in this invention.

### BACKGROUND OF THE INVENTION

Nanoporous membranes have been proposed for a number of uses, for example, in catalysis, templating, water filtration, gas separation, biofiltration, biomolecule separation, drug delivery, and battery or fuel cells. While nanoporous membranes prepared from inorganic materials generally exhibit chemical, thermal and/or mechanical stability, those prepared from organic materials (e.g., polymers) offer enhanced chemical tunability and mechanical flexibility. Many industrial applications require flexible, thin (<500 nm thick) films, and therefore, polymers have been considered as starting materials for preparing nanoporous membranes.

Some of the challenges in implementing nanoporous membranes from polymers include realizing the desired mechanical integrity of the final porous structure. For example, some of the membranes tend to be brittle or inflexible or the pores tend to collapse under certain processing or operating conditions.

The foregoing shows that there exists an unmet need for nanoporous membranes having one or more of the desired properties.

### BRIEF SUMMARY OF THE INVENTION

The foregoing need has been fulfilled to a great extent by the present invention which provides a porous membrane comprising nanoporous cross-linked poly(styrene)-block-poly(isoprene)-block-poly(styrene).

In an embodiment, the nanoporous cross-linked poly(styrene)-block-poly(isoprene)-block-poly(styrene) has a thickness in the range of from about 20 nanometers (nm) to about 500 nm. Typically, the membrane has a pore diameter of at least about 2 nanometers, e.g., in the range of from about 2 nanometers to about 100 nanometers.

Another embodiment of the invention comprises a composite, the composite comprising a porous membrane comprising nanoporous cross-linked poly(styrene)-block-poly(isoprene)-block-poly(styrene) on a microporous support. In an embodiment, the microporous support comprises a microporous membrane, preferably, a microporous polymeric membrane. In an embodiment, the microporous support comprises a sulfone membrane, preferably, a polyethersulfone membrane.

In some embodiments, the membrane and/or composite is prepared by a process including, for example, spin coating, salt-plate transfer/film-transfer, tape casting, or dip coating.

In some embodiments, the porous membrane comprising nanoporous cross-linked poly(styrene)-block-poly(isoprene)-block-poly(styrene) is produced by process comprising preparing poly(styrene)-block-poly(isoprene)-block-poly(styrene)-block-poly(d,l-lactide) tetrablock terpolymer, and hydrolyzing poly(d,l-lactide). In an embodiment, the process includes hydrolyzing poly(d,l-lactide) and reactive ion etching. Alternatively, or additionally, the process can include spin coating poly(styrene)-block-poly(isoprene)-block-poly(styrene)-block-poly(d,l-lactide) tetrablock terpolymer onto a microporous liquid-filled support, or spin coating poly(styrene)-block-poly(isoprene)-block-poly(styrene)-block-poly(d,l-lactide) tetrablock terpolymer onto a salt plate, dissolving the salt plate, and transferring the tetrablock terpolymer to a microporous support.

The invention further provides a process for preparing the porous membrane comprising reacting a hydroxyl-terminated poly(styrene)-block-poly(isoprene)-block-poly(styrene) block polymer with a d,l-lactide to form a tetrablock copolymer poly(styrene)-block-poly(isoprene)-block-poly(styrene)-poly(d,l-lactide), forming the tetrablock copolymer into a nano-structured thin film having a continuous matrix phase and a dispersed phase, wherein the continuous matrix phase comprises the poly(isoprene) block and the dispersed phase comprises the poly(styrene) block and the poly(d,l-lactide) block, and selectively removing at least a portion of the poly(d,l-lactide) block.

The present invention capitalizes on a property of block polymers in that they can self-organize into well-ordered structures having nanoscopic domains with a uniform size distribution. For example, in accordance with embodiments, the tetrablock copolymer precursors of the invention form a structure having core-shell cylinder morphology. By removal of a sacrificial minority component, such ordered precursors are converted into a variety of nanoporous materials. The nanoscopic pores of the present membranes are well-suited for demanding separation applications (e.g., removal of viruses by size exclusion) while the narrow pore-size distribution fosters remarkable selectivity. Furthermore, the block polymers can be advantageously designed to incorporate desired chemical, thermal, and mechanical attributes appropriate to specific applications.

The nanoporous membrane of the present invention is crosslinked by virtue of the structure of the block polymer itself, i.e., by the way the blocks organize themselves in the solid state. The membrane is crosslinked by physical crosslinking between glassy domains formed during self-assembly and entanglement of the rubbery middle block. No chemical crosslinking agent is used to bring about the crosslinking. The nanoporous membranes have superior mechanical properties compared to non-crosslinked nanoporous membranes made from polystyrene or poly(isoprene)-block-poly(styrene) copolymer. The nanoporous membranes of the invention have hexagonally packed cylinder morphology.

### BRIEF DESCRIPTION OF THE SEVERAL VIEWS OF THE DRAWING(S)

FIG. 1, A, depicts the self-organization of a PS-PI-PS-PLA tetrablock polymer into the core-shell cylinder morphology followed by selective removal of PLA to generate a nanoporous thermoplastic elastomer (PS-PI-PS). FIG. 1, B, illustrates the structure of a composite membrane in accordance with an embodiment of the invention containing a nanoporous PS-PI-PS layer coated on a microporous polyethersulfone membrane support.

FIG. 2 depicts a synthetic scheme to prepare PS-PI-PS-OH and PS-PI-PS-PLA polymers in accordance with an embodiment of the invention.

FIG. 3 depicts the 1D-SAXS (a) of PS-PI-PS-PLA polymer (f_{PLA}=0.21) taken at 25° C., after channel-die alignment at 150° C. Triangles indicate theoretical q/q* ratios of √3: √4: √7: √9: √13: √16: and √25 associated with the hexagonal packed cylinder morphology. FIG. 3 also depicts an illustration of the channel-die apparatus (b) showing the direction of flow along z-axis. FIG. 3 also depicts the 2D morphology characterization (c) of the XY plane (Bottom, 2D SAXS pattern; Top, TEM of XY face of microtomed channel-die stick). FIG. 3 further depicts the 2D morphology characterization (d) of the YZ plane (Bottom 2D SAXS pattern; Top, TEM of YZ face of microtomed channel-die stick). Scale bar is 100 nm.

FIG. 4 depicts a scanning electron micrograph (SEM) of the microporous polyethersulfone (PES) before it was coated (A). FIG. 4 also depicts the SEM of PS-PI-PS-PLA (0.21)/PLA blend coated PES support after direct spin coating (B). FIG. 4 further depicts the tapping mode AFM phase image of surface of spin coated film coated on of PES support (C). FIG. 4 further depicts the SEM of nanoporous selective layer after PLA hydrolysis (D).

FIG. 5 depicts the tapping mode AFM images of the surface of PS-PI-PS-PLA (0.21) films spin coated onto water filled PES support from toluene (a). FIG. 5 also depicts the tapping mode AFM images of the surface of PS-PI-PS-PLA (0.21)/PLA films spin coated onto water filled PES support from toluene (b). Scale bars are 500 nm.

FIG. 6 depicts permeability data of a composite PS-PI-PS/PES membrane in accordance with an embodiment of the invention (a). Permeability of 96.9 L m⁻²h⁻¹bar⁻¹ was found from the slope of the linear fit (solid line). FIG. 6 also depicts the UV-Vis absorbance data (b) obtained on standard fluorescent dextran solution (1) and filtrate (2).

FIG. 7 depicts the ¹H NMR spectrum taken immediately after addition of isoprene to the polymerization mixture containing poly(styrene). The amount of the first block of polystyrene was calculated from the polystyryl resonances between 6.2 and 7.2 ppm. Sec-butyl end group resonances between 0.6 and 1 ppm were used to calculate the degree of polymerization of styrene. A small amount of polyisoprene was present because the aliquot was taken a few minutes after addition of the isoprene monomer.

FIG. 8 depicts the ¹H NMR spectrum of PS-PI-PS-OH in CDCl₃ at 25° C. Mn was calculated by a combination of ¹H NMR end group analysis. SEC data of the PS first block aliquot was based on PS standards. End group analysis by ¹H NMR was performed using the end group found at the CH₂ resonances at 3.3 ppm and again with the sec-butyl end group at 0.5-0.9 ppm (not shown here, see FIG. 6). Molecular weights calculated by end group analysis were in agreement within the limits of experimental error (98% agreement).

FIG. 9 depicts the size exclusion chromatographic (SEC) traces obtained on aliquot taken after polymerization of the first block, PS (dashed line) and PS-PI-PS-OH triblock (solid black line). Small peaks at 22 mL and at 20.5 mL in the aliquot trace are due to the coupling of chains in the aliquot during removal from the reaction flask.

FIG. 10 depicts the ¹H NMR spectrum of PS-PI-PS-PLA (0.20) in CDCl₃ at 25° C. End group analysis was performed using the methylene resonance at 3.8 ppm and also with the sec-butyl end group at 0.5-0.9 ppm (not shown). The degree of polymerization calculated both ways gave identical molecular weight for the PS-PI-PS-PLA tetrablock.

FIG. 11 depicts the SEC traces for PS-PI-PS-OH (4), PS-PI-PS-PLA (0.19) (3), PS-PI-PS-PLA (0.20) (2), and PS-PI-PS-PLA (0.25) (1).

FIG. 12 depicts the DSC curves for PS-PI-PS-OH (a), PS-PI-PS-PLA (0.20) (b), PS-PI-PSPLA (0.21) (c), and PS-PI-PS-PLA (0.25) (d). Curves have been shifted vertically to show them more clearly.

FIG. 13 depicts the raw data plot (A) and the derivative plot (B) of DSC data for PS-PI-PS-OH and PS-PI-PS-PLA, showing glass transition temperatures for PS and PLA blocks. Individual curves shown in each are PS-PI-PS-PLA (0.25) (a), PS-PI-PS-PLA (0.21) (b), PS-PI-PSPLA (0.20) (c), and PS-PI-PS-OH (d). Curves have been shifted vertically to show them more clearly.

FIG. 14 depicts the room temperature 1D-SAXS data for channel-die aligned PS-PI-PS-PLA (0.20) with corresponding 2D-SAXS patterns. Scattering from the XY plane, left; XZ plane, middle; and the YZ plane, right. Triangles indicate theoretical reflections for q/q* of 1, √3: √4: √7: √9: √13: √16: √19: and √25 associated with the hexagonally-packed cylinder morphology.

FIG. 15 depicts the representative diagram of integrated area used for each sample (A). FIG. 15 also depicts the normalized orientation distribution function (P(β)) from channel-die aligned PS-PI-PSPLA polymers with f_{PLA} of (a) 0.20 (F₂=0.65), (b) 0.21 (F₂=0.77), and (c) 0.25 (F₂=0.72) (B).

FIG. 16 depicts the TEM of the XY face of channel-die aligned polymers PS-PI-PS-OH (a), PS-PIPS-PLA (0.20) (b), PS-PI-PS-PLA (0.21) (c), PS-PI-PS-PLA (0.25) (d). Samples were cryo-microtomed into appr. 60-70 nm thick samples at −100° C. and then stained with osmium tetroxide for about 10 minutes before imaging. Black regions are due to the stained polyisoprene domains. White domains contain both polystyrene and polylactide blocks. Scale bars are 100 nm.

FIG. 17 depicts the TEM of the XY face of channel-die aligned polymers PS-PI-PS-PLA (0.25) (a), and TEM of YZ face of PS-PI-PS-PLA (0.25) (b). Samples were cryo-microtomed into appr. 60-70 nm thick samples at −100° C. and then stained with osmium tetroxide for about 10 minutes before imaging. Black regions are due to stained polyisoprene domains. White domains contain both polystyrene and polylactide blocks. Scale bars are 100 nm.

FIG. 18 depicts the TEM of film of PS-PI-PS-PLA (0.19) drop cast onto TEM grid from 0.1 wt % toluene solution. Different regions of the film showed different cylinder orientation: some are parallel, as shown in (A), and some are perpendicular and parallel, as shown in (B). The high contrast in image (A) shows 3 distinct domains: Black is polyisoprene, white is polystyrene and the light grey between the white polystyrene domains is polylactide. The slight contrast between PS and PLA is due to the inherent difference in electron density between PS and PLA since neither is stained with OsO₄. Less contrast is evident for the perpendicular regions. Film was stained with OsO₄ for about 10 minutes before imaging. Black regions are due to stained polyisoprene domains. Scale bars are 300 nm.

FIG. 19 depicts the TEM of film of PS-PI-PS-PLA (0.19) drop cast onto TEM grid from 0.1 wt % toluene solution. The film was stained with OsO₄ for about 10 minutes before imaging. Black regions are due to stained polyisoprene domains. Scale bar is 300 nm.

FIG. 20 depicts the stress vs. strain data for PS-PI-PS-OH (dog bone sample).

FIG. 21 depicts the stress vs. strain data for dog bone samples made of PS-PI-PS-PLA (0.21) (A), PSPI-PS-PLA (0.20) (B), and PS-PI-PS-PLA (0.25) (C).

FIG. 22 depicts the stress vs. strain data for dog bone samples made of PS-PI-PS-PLA (0.20).

FIG. 23 depicts the stress vs. strain data for dog bone samples made of PS-PI-PS-PLA (0.25).

FIG. 24 depicts the SEM images of the XY face of etched channel-die aligned PS-PI-PS-PLA (0.20) after etching at room temperature with 60/40 water/methanol in 0.5 M NaOH with 0.1 wt % SDS.

FIG. 25 depicts real (left) and binary (right) SEM images of the surface of the support. Right image was used to estimate average pore size and pore surface area. Scale bars in both are 1 μm.

FIG. 26 illustrates a procedure for direct coating of a PS-PI-PS-PLA polymer onto a polyethersulfone support by spin coating, followed by removal of the PLA blocks, in accordance with an embodiment of the invention.

FIG. 27 illustrates a procedure for coating of a PS-PI-PS-PLA polymer via the salt plate transfer method in accordance with an embodiment of the invention.

FIG. 28 depicts the SEM images of the composite membrane surfaces after spin coating from toluene solution (a), chlorobenzene solution (b), and THF solution (c). Scale bars are 7.5 μm.

FIG. 29 depicts the SEM images of the surface of the membrane prepared by the salt plate method in accordance with an embodiment of the invention. The SEM images were taken after base etching and flux test. High magnification, medium magnification, and lower magnification are shown in a-c, respectively.

FIG. 30 depicts the permeability data for a directly coated membrane in accordance with an embodiment of the invention.

FIG. 31 depicts the UV-Vis absorbance data for TRITC-dextran standard solutions and filtrate.

FIG. 32 depicts the UV-Vis absorbance data obtained from the PES support cut-off test, showing that the support is completely permeable to the solute.

### DETAILED DESCRIPTION OF THE INVENTION

In an embodiment, the invention provides a porous membrane comprising nanoporous cross-linked poly(styrene)-block-poly(isoprene)-block-poly(styrene).

The poly(styrene) and poly(isoprene) blocks can be of any suitable lengths. For example, in embodiments, the poly(styrene) block can have a number average molecular weight (Mn) of from about 1 to about 100 kg/mol, about 1 to about 10 kg/mol, or about 2 to about 8 kg/mol. In certain embodiments, the poly(styrene) block has an Mn of about 3, 4, 5, 6, 7, or 8 kg/mol.

The poly(isoprene) block can have a number average molecular weight (Mn) of from about 2 to about 200 kg/mol, about 2 to about 20 kg/mol, or about 4 to about 16 kg/mol. In certain embodiments, the poly(isoprene) block has an Mn of about 5, 6, 7, 8, 9, 10, 11, 12, 13, 14, or 15 kg/mol.

In accordance with an embodiment of the invention, the poly(styrene) and poly(isoprene) blocks can be present in the PS-PI-PS block polymer in any suitable volume fractions. For example, each of the poly(styrene) and poly(isoprene) blocks can be present in a volume fractions of from about 30 to 70%, about 40 to about 60%, or about 45 to about 55%, with the volume fractions adding up to 100%. In certain embodiments, each of the poly(styrene) and poly(isoprene) blocks can be present at about 46%, 47%, 48%, 49%, or 50%. Thus, in embodiments, the composition can include PS and PI blocks in a volume fraction ratio of 46%/54%, 47%/53%, 48%/52%, 49%/51%, 50%/50%, 51%/59%, 52%/48%, 53%/47%, or 54%/46%.

The PS-PI-PS block polymer preferably has a narrow dispersity index, e.g., Mw/Mn is less than about 1.25, preferably less than about 1.20, and more preferably less than about 1.10. In embodiments, the PS-PI-PS block polymer has an Mw/Mn of 1.00 to 1.10, for example, 1.01, 1.02, 1.03, 1.04, 1.05, 1.06, 1.07, 1.08, or 1.09.

The nanoporous cross-linked poly(styrene)-block-poly(isoprene)-block-poly(styrene) of the porous membrane can have any suitable thickness, for example, a thickness of at least 20 nm, at least 30 nm, at least 40 nm, at least 50 nm, at least 60 nm, at least 70 nm, at least 80 nm, at least 90 nm, at least 100 nm, at least 150 nm, at least 200 nm, at least 250 nm, at least 300 nm, at least 350 nm, or at least 400 nm.

The nanoporous cross-linked poly(styrene)-block-poly(isoprene)-block-poly(styrene) of the porous membrane can have any suitable thickness, for example, a thickness of about 400 nm or less, about 350 nm or less, about 300 nm or less, about 250 nm or less, about 200 nm or less, about 150 nm or less, about 100 nm or less, about 80 nm or less, about 60 nm or less, or about 40 nm or less.

The nanoporous cross-linked poly(styrene)-block-poly(isoprene)-block-poly(styrene) of the porous membrane can have any suitable thickness, for example, in the range of from about 20 nm to about 500 nm, from about 30 nm to 400 nm, from about 40 nm to about 300 nm, from about 50 nm to about 200 nm, or from about 60 nm to about 100 nm.

The membrane in accordance with any of the embodiments above can have any suitable pore size, for example, a pore diameter of at least about 2 nm, about 5 nm, about 10 nm, about 15 nm, about 20 nm, about 30 nm, about 40 nm, or about 50 nm, or a pore diameter of about 100 nm or less, about 80 nm or less, about 60 nm or less, about 40 nm or less, or about 20 nm or less. Thus, for example, the membrane has a pore size of from about 2 nm to about 100 nm, from about 5 nm to about 100 nm, about 10 nm to about 100 nm, or about 20 nm to about 100 nm. In embodiments, the membrane has a pore size of from about 2 nm to about 20 nm, from about 5 nm to about 30 nm, about 10 nm to about 50 nm, or about 20 nm to about 80 nm.

The invention further provides a process for preparing the porous membrane comprising reacting a hydroxyl-terminated poly(styrene)-block-poly(isoprene)-block-poly(styrene) block polymer with a d,l-lactide to form a tetrablock copolymer poly(styrene)-block-poly(isoprene)-block-poly(styrene)-poly(d,l-lactide), forming the tetrablock copolymer into a nano-structured thin film having a continuous matrix phase and a dispersed phase, wherein the continuous matrix phase comprises the poly(isoprene) block and the dispersed phase comprises the poly(styrene) block and the poly(d,l-lactide) block, and selectively removing at least a portion of the poly(d,l-lactide) block.

Any suitable portion of the PLA domains can be removed. For example, at least about 5% of the PLA domains are removed, and in embodiments, at least about 10%, at least about 15%, at least about 20%, at least about 25%, at least about 30%, at least about 35%, at least about 40%, or at least about 50%, or more, of the PLA domains are removed. In embodiments, at least about 5%, at least about 10%, at least about 15%, at least about 20%, at least about 25%, at least about 30%, at least about 35% at least about 40%, or at least about 50%, or more, of the pores of the nano nanoporous cross-linked poly(styrene)-block-poly(isoprene)-block-poly(styrene) membrane are open. For example, in an embodiment, approximately 27% of pores are open for the salt plate method membrane and approximately 15% of pores open for the directly coated membrane.

In an embodiment of the process, the tetrablock copolymer is dissolved in a solvent and the tetrablock copolymer solution is cast as a nano-structured thin film.

In an embodiment of the above process, the tetrablock copolymer solution further contains a poly(d,l-lactide) homopolymer.

In an embodiment, the process further includes removing at least a portion of the poly(d,l-lactide) homopolymer from the nano-structured thin film.

The invention further provides a composite comprising the membrane of any of the above embodiments in combination with a microporous support. Any suitable microporous support can be used, for example, polymeric, ceramic, metallic, or non-metallic. The microporous support can be a flat sheet support, a tubular support, or a hollow fiber support. The microporous support can have any suitable pore size. For example, the microporous support can have a pore diameter of 1 μm or greater. In embodiments, the pore diameter is from about 10 μm to about 100 μm, about 10 μm to about 50 μm, or about 10 μm to 30 μm.

For example, the microporous support can be a microporous membrane. Any suitable microporous membrane can be used, for example, a microporous polymeric membrane. Examples of microporous polymeric membranes include, but are not limited to, sulfone membranes, cellulose based membranes including cellulose acetate, cellulose triacetate, CA/triacetate blend membranes, cellulose nitrate membranes, regenerated cellulose membranes, polyolefin membranes, polyester membranes, polyamide membranes, polyimide membranes, polycarbonate membranes, polyphenylene oxide membranes, polyacrylonitrile membranes, polybenzimidazole membranes, PTFE membranes, polyether ketone membranes, polyether ether ketone membranes, polyvinylidene membranes, polyvinyl chloride membranes, and membranes made of blends or copolymers thereof.

In an embodiment, sulfone membranes are preferred as the microporous support. Examples of sulfone membranes include polysulfone membrane and polyethersulfone membrane, preferably a polyethersulfone membrane.

The composite can be prepared by any suitable method, for example, by spin coating, salt-plate transfer/film-transfer process. Thus, for example, a composite is produced by a process comprising coating a solution of poly(styrene)-block-poly(isoprene)-block-poly(styrene)-block-poly(d,l-lactide) tetrablock terpolymer onto a microporous liquid-filled support.

Any suitable solvent can be used to prepare the tetrablock terpolymer solution, for example, a nonpolar organic solvent. Examples of nonpolar organic solvents include toluene and chlorobenzene. Tetrahydrofuran and chloroform are other suitable solvents. The tetrablock terpolymer solution can be coated by any suitable coating technique, e.g., dip coating, spray coating, meniscus coating, or spin coating.

Preferably, the pores of the support are filled with a polar solvent immiscible with the solvent of the tetrablock terpolymer solution prior to coating the solution. Examples of polar immiscible solvents include water and alcohols.

Alternatively, the composite is produced by coating, for example, spin coating, poly(styrene)-block-poly(isoprene)-block-poly(styrene)-block-poly(d,l-lactide) tetrablock terpolymer onto a salt plate, dissolving the salt plate, and transferring the resulting tetrablock terpolymer film to a microporous support.

Following the above process step, at least a portion of the poly(d,l-lactide) (or PLA) is removed from the tetrablock terpolymer. The PLA block can be removed by any suitable process, e.g., by hydrolysis by an acid or a base, or by reactive ion etching (RIE). For example, PLA can be etched by the use of a basic solution (0.5 M NaOH) of 60:40 (v:v) water:methanol at 65° C. Bailey, T. S., et al., Macromolecules 2006, 39, 8772-8781.

The PS-PI-PS block copolymer can be prepared by sequential anionic polymerization of styrene, isoprene, and then styrene, which can be initiated by any suitable initiator, for example, sec-butyllithium in a hydrocarbon solvent under an inert atmosphere. At the end of the polymerization, the chain ends are capped by reacting with ethylene oxide to provide hydroxyl chain ends.

The PS-PI-PS-PLA block copolymer can be prepared by any suitable method. For example, a hydroxyl-terminated PS-PI-PS block copolymer is first produced, which is then polymerized with L-lactide catalyzed with diazabicyclo[5,4,0]undec-7-ene (DBU).

The PLA fragment can be present in the PS-PI-PS-PLA block copolymer in any suitable fraction, for example, in a volume fraction of at least 10%. In embodiments, the PLA fragment is present in a volume fraction of from about 14% to about 30%, from about 15% to 25%, or from about 18% to about 24%. In certain embodiments, the PLA fragment is present in a volume of fraction of about 15%, about 16%, about 17%, about 18%, about 20%, about 21%, about 22%, about 23%, about 24%, or about 25%.

In embodiments, the PI fragment can be present in the PS-PI-PS-PLA block copolymer in any suitable fraction, for example, in a volume fraction of at least about 30%. In embodiments, the PI fragment is present in a volume fraction of from about 32% to about 50%, from about 35% to 49%, or from about 36% to about 48%.

In embodiments, the PS fragment can be present in the PS-PI-PS-PLA block copolymer in any suitable fraction, for example, in a volume fraction less than about 60%. In certain embodiments, the PS fragment is present in a volume fraction of from about 35% to about 60%, from about 36% to about 55%, or from about 38% to about 52%.

PS-PI-PS-PLA block polymer can have any suitable molecular weight. For example, the PS-PI-PS-PLA block polymer can have a number average molecular weight (Mn) of at least 10 kg/mol. In embodiments, the PS-PI-PS-PLA block polymer has an Mn of from about 15 kg/mol to about 35 kg/mol, about 20 kg/mol to about 32 kg/mol, or about 25 kg/mol to about 30 kg/mol.

The PS-PI-PS-PLA block polymer preferably has a narrow dispersity index, e.g., Mw/Mn is less than about 1.25, preferably less than about 1.20, and more preferably less than about 1.15. In embodiments, the PS-PI-PS-PLA block polymer has an Mw/Mn of 1.00 to 1.10, for example, 1.01, 1.02, 1.03, 1.04, 1.05, 1.06, 1.07, 1.08, or 1.09.

Membranes according to embodiments of the invention can be used in a variety of applications, including, for example, diagnostic applications (including, for example, sample preparation and/or diagnostic lateral flow devices), ink jet applications, filtering fluids for the pharmaceutical industry, filtering fluids for medical applications (including for home and/or for patient use, e.g., intravenous applications, also including, for example, filtering biological fluids such as blood (e.g., to remove leukocytes)), filtering fluids for the electronics industry (e.g., filtering photoresist fluids in the microelectronics industry), filtering fluids for the food and beverage industry, clarification, filtering antibody- and/or protein-containing fluids, filtering nucleic acid-containing fluids, cell detection (including in situ), cell harvesting, and/or filtering cell culture fluids. Alternatively, or additionally, membranes according to embodiments of the invention can be used to filter air and/or gas and/or can be used for venting applications (e.g., allowing air and/or gas, but not liquid, to pass therethrough). Membranes according to embodiments of the inventions can be used in a variety of devices, including surgical devices and products, such as, for example, ophthalmic surgical products.

The present invention further provides a device, e.g., a filter device, chromatography device and/or a membrane module comprising one or more membranes of the present invention disposed in a housing. The device can be in any suitable form. For example, the device can include a filter element comprising the membrane in a substantially planar, pleated, or spiral form. In an embodiment, the element can have a hollow generally cylindrical form. If desired, the device can include the filter element in combination with upstream and/or downstream support or drainage layers. The device can include a plurality of membranes, e.g., to provide a multilayered filter element, or stacked to provide a membrane module, such as a membrane module for use in membrane chromatography.

The filter, in some embodiments comprising a plurality of filter elements, is typically disposed in a housing comprising at least one inlet and at least one outlet and defining at least one fluid flow path between the inlet and the outlet, wherein the filter is across the fluid flow path, to provide a filter device. In another embodiment, the filter device comprises a housing comprising at least one inlet and at least a first outlet and a second outlet, and defining first fluid flow path between the inlet and the first outlet, and a second fluid flow path between the inlet and the second outlet, wherein the filter is across the first fluid flow path, e.g., allowing tangential flow such that the first liquid passes along the first fluid flow path from the inlet through the filter and through the first outlet, and the second fluid passes along the second fluid flow path from the inlet and through the second outlet without passing through the filter.

The following examples further illustrate the invention but, of course, should not be construed as in any way limiting its scope.

### Example 1

This example illustrates the experimental details involved in producing and characterizing the block copolymers used in the preparation of a membrane in accordance with an embodiment of the invention.

Materials: Styrene (99%, 10-15 ppm 4-tert-butylcatechol inhibitor, Aldrich) was purified by one distillation from calcium hydride (90-95%, Aldrich) and a successive distillation from butylmagnesium chloride (˜3 mL/50 g styrene, 2.0 M solution in diethyl ether, Aldrich) under a static vacuum of 10-20 mTorr. Isoprene (99%, 100 ppm p-tert-butylcatechol inhibitor, Aldrich) was purified by two successive vacuum distillations from n-butyllithium (−3 mL/50 g isoprene, 2.5 M solution in hexanes, Aldrich). Ethylene oxide (99.5+%, compressed gas, Aldrich) was distilled once from butylmagnesium chloride (1 mL/10 ml, ethylene oxide). Cyclohexane was purified by passage through activated alumina and a supported copper redox catalyst under high-purity argon in home-built columns. Sec-Butyllithium (1.3 M solution in cyclohexane, Aldrich) was used as received. The 50/50 (v:v) methanol/isopropanol solution used for reaction termination was degassed with nitrogen prior to use. d,l-Lactide was recrystallized from ethyl acetate and stored under nitrogen in a glovebox before use. All other chemicals were used as received without purification.

Characterization: ¹1-NMR Spectroscopy experiments were performed at room temperature on a Varian Inova 500 instrument operating at 500 MHz. Solutions of polymer were prepared in CDCl₃ at a concentration of approximately 15 mg/mL. All spectra were obtained at 25° C. after 32 transients using a relaxation delay of 5 s with chemical shifts reported as 8 (ppm) relative to the ¹H signals of CHCl₃ at 7.27 ppm.

Size-exclusion chromatography (SEC) was used to characterize the dispersity (D) and molecular weight evolution for the PS aliquot, PS-PI-PS-OH triblock, PS-PI-PS-PLA tetrablocks and PLA etched PS-PI-PS-PLA monoliths. Samples were prepared at concentrations between 1-5 mg/mL in CHCl₃. SEC was performed at 35° C. using three Plgel 5 μm Mixed-C columns in series with an available molecular weight range of 400-400,000 g mol⁻¹. The columns are contained in a Hewlett-Packard (Agilent Technologies) 1100 series liquid chromatograph equipped with a Hewlett-Packard 1047A refractive index detector. Molecular weight and D values are reported with respect to polystyrene standards obtained from Polymer Laboratories.

Differential scanning calorimetric (DSC) analysis was performed on a Q1000 instrument from TA Instruments calibrated with an Indium standard. The samples were heated to 150° C. and then subsequently cooled to −100° C. followed by heating again to 150° C. Samples were heated and cooled at a rate of 10° C. min⁻¹. The data presented herein and glass transitions temperature measurements were taken from the second heating ramp. Data analysis (T_{g}) was performed on TA Instruments Universal Analysis software.

Small-angle X-ray scattering (SAXS) experiments were performed at the Sector 5-ID-D beamline of the Advanced Photon Source (APS) at Argonne National Laboratories, maintained by the Dow-Northwestern-DuPont Collaborative Access Team (DNDCAT). The source produces X-rays with 0.84 Å wavelength. For the experiments reported here, the sample to detector distance was fixed to 4.042 m and the detector radius was 81 mm. Scattering intensity was monitored using a Mar 165 mm diameter CCD detector operating with a resolution of 2048 by 2048. The two dimensional scattering patterns were azimuthally integrated to afford one-dimensional profiles presented as spatial frequency (q) versus scattered intensity.

Using the 2D-scattering pattern, analysis of the change in primary scattering vector, q*, intensity with respect to azimuthal angle β was studied for each PS-PI-PSPLA tetrablock to determine the degree of cylinder alignment. A normalized orientation distribution function (P, eq. 1) was calculated followed by the calculation of F₂ for each 2D-SAXS pattern (eq. 2 and 3).

$$\begin{matrix}P ( β ) = \frac{I ( {q}^{*} , β ) {q}^{* 2}}{{\int }_{0}^{π} I ( {q}^{*} , β ) {q}^{* 2} sin β d β} & ( eq 1 ) \\ {P}_{2} = 1 - 3 ( {cos}^{2} β ) & ( eq 2 ) \\ ( {cos}^{2} β ) = {\int }_{0}^{π} {cos}^{2} β P ( β ) sin β d β & ( eq 3 )\end{matrix}$$

Transmission Electron Microscopy (TEM): Ultrathin sections (ca. 70 nm) of the polymer films were cut using a Reichert UltraCut S Ultramicrotome with a Model FC-S addition at −100° C. Thin sections were placed on 300 mesh copper grids and subsequently stained with osmium tetroxide vapor for about 10 min by exposure to a 4% aqueous solution. TEM analysis was performed on a JEOL JEM-1210 transmission electron microscope operating at 100 kV equipped with a Gatan Multiscan CCD camera.

Tensile tests were performed using small rectangular samples of the polymers that were cut from a sample pressed for 10 minutes at 150° C. under 1000 psi. The samples had the approximate dimensions of 0.5 mm (7)×3 (W)×7 mm (L). The tensile measurements were performed on a Rheometrics Scientific MiniMat instrument. Samples were extended lengthwise uniaxially at 2.0 mm min⁻¹.

Scanning Electron Microscopy (SEM): Etched and dried tetrablocks were coated with 3 nm of Pt via direct Pt sputter coating prior to imaging with SEM. SEM was performed on a Hitachi S-900 FE-SEM at 2 kV. Prior to SEM characterization, samples were coated with about 2-3 nm of platinum with a VCR Ion Beam Sputter Coater to limit surface charging.

Atomic Force Microscopy (AFM): AFM surface morphological analysis was performed using an Agilent 5500 environmental SPM plus inverted light microscopy with Olympus tapping mode at ambient conditions using commercial Silicon™ tips (Veeco Instruments).

Ellipsometry: Ellipsometry was performed using a J. A. Woolam, EC-2000 ellipsometer, with incident angles of 60 and 75°, and laser wavelengths between 400 and 1100 nm.

Filtration Test: Water flow rate experiments were performed in a small dead-end ultrafiltration cell (AMICON® 8010 filtration cell, membrane diameter 25 mm, volume 10 mL, stirring speed 600 rpm). Solute rejection tests were performed using 0.5 mg mL⁻¹ TRITC-Dextran solutions in HPLC grade water at a stirring speed of 600 rpm and pressure of 0.2 bar. Concentration of the collected solutions was determined with UV-Vis spectrometry. UV-Vis absorption spectra for all solutions were determined on a Spectronic Genesys 5 spectrometer over a wavelength range of 300-1000 nm. Solution spectra were obtained in a 1 cm polystyrene cuvette. HPLC grade water was used as the baseline for all measurements. UV absorbance (at λₘₐₓ=521 nm) vs. TRITC-Dex concentration was calibrated with TRITC-Dex solutions of varying concentration (0, 0.05, 0.1, 0.125, 0.25, 0.375 and 0.5 mg/mL). Calibration was performed three times.

Representative Synthesis of PS-PI-PS-OH: The synthesis of the PS-PI-PS-OH triblock precursor was done using a method described by Bailey et al. (Bailey, T. S., et al., Macromolecules 2001, 34, 6994-7008). Sequential anionic polymerization of styrene (19.91 g, 5H), isoprene (35.87 g, 4H), and then styrene (21.79 g, 5H) was initiated by sec-butyllithium (2.636 mL, 1.3 M) in cyclohexane under appr. 5 psi positive pressure of argon. After polymerization, a 150 fold excess of ethylene oxide (18.43 mL) was added to cap the growing PS-PI-PS chain ends with one unit of ethylene oxide. All glassware was dried in a 105° C. oven overnight and flame-dried under vacuum before use. Yield=75.7 g (97.6%). SEC (PS standards): PS fragment Mₙ=5,700 kg/mol, M_{w}/Mₙ=1.04, PS-PI-PS-OH Mₙ (by ¹H NMR spectroscopy and SEC of PS fragment)=21.3 kg/mol, M_{w}/Mₙ=1.05. ¹H NMR (ppm downfield from TMS): 6.20-7.26 (b, —(C₆H₅)), 4.90-5.30 (b, —CH₂— CH═C(CH₃)—CH₂—), 4.60-4.90 (b, CH₂═C(CH₃)—), 3.5-3.7 (m, —CH₂—OH), 0.84-2.40 (b, CH₂═C(CH₃)—C(R)HCH₂—, —CH₂—CH═C(CH₃)—CH₂—, and C₆H₅—C(R)H—CH₂—), 0.5-0.78 (m, —CH₃, initiator fragment).

Representative Synthesis of PS-PI-PS-PLA: Polymerizations of d,l-lactide initiated by the PS-PI-PS-OH parent triblock were carried out by the polymerization of d,l-lactide catalyzed with diazabicyclo[5,4,0]undec-7-ene (DBU). The procedure for PS-PI-PS-PLA (0.20) is given below as a representative synthesis for PS-PI-PS-PLA tetrablocks. PS-PI-PS-OH (1.00 g) and d,l-lactide (0.475 g) were dissolved in dry methylene chloride (10 mL) in a glass scintillation vial in a nitrogen glove box. DBU (7 μL) was then added to initiate the polymerization. The vial was then sealed with a Teflon-lined screw cap, removed from the glove box, and placed on a stir plate. Polymerizations were run for 60 minutes at room temperature in order to reach around 80% conversion of d,l-lactide. After 60 minutes, a small amount of benzoic acid (about 5-10 mg) was added to terminate the reaction. The polymer was precipitated with methanol, filtered and dried in vacuo (50° C. for 48 h). Yield=1.13 g (77% d,l-lactide conversion). Mn (by ¹H NMR spectroscopy)=27.5 kg/mol, PDI (PS standards): M_{w}/Mₙ=1.07. ¹H NMR (ppm downfield from TMS): 6.20-7.26 (b, —CH(C₆H₅)), 4.90-5.30 (b, —CH₂—CH═C(CH₃)—CH₂—), 4.98-5.28 (b, —C(O)CH(CH₃)O—), 4.60-4.90 (b, —CH₂═C(CH₃)—), 4.30-4.42 (m, —C(O)CH(CH₃)OH), 3.95-4.15 (b, —CH₂CH₂—O—), 2.60-2.75 (bd, —C(O)CH(CH₃)OH), 0.84-2.40 (b, CH₂═C(CH₃)—C(R)H—CH₂—, —CH₂—CH═C(CH₃)—CH₂—, —C(O)CH(CH₃)O—, and C₆H₅—C(R)H—CH₂—), 0.5-0.78 (m, —CH₃, initiator fragment).

Degradation Conditions: Channel-die aligned samples were cryo-cut into 3×3×1.5 min cubes before being subjected to etching conditions. Prior to etching, each sample was placed in a Dewar of liquid nitrogen for 1 minute and then immediately broken in half. In all degradation experiments, PS-PI-PS-PLA cubes were allowed to react in dilute basic conditions without stirring for one month. A series of basic solutions with solvents of different polarities was tested to find improved degradation conditions. The five solutions tested all contained 0.5 M NaOH, 0.1 wt % SDS and one of the following five solvents or solvent mixtures: 1) Water, 2) 40:60 (v:v) Methanol: Water, 3) 70:30 (v:v) Methanol:Water, 4) Methanol, and 5) Ethanol. Cubes were also placed in one of the five corresponding control solutions (same as etching solutions but without NaOH) for 1 month. All samples were rinsed (appr. 20 seconds) with the control solutions, deionized water and then directly dissolved in chloroform for SEC analysis. SEM verified the formation of nanopores after basic etching at room temperature. Ethanolic and methanolic etching solutions proved superior to more hydrophilic etching solutions in removing PLA.

### Example 2

This example demonstrates a method of synthesis of tetrablock terpolymers which are useful in the preparation of a nanoporous membrane of the invention.

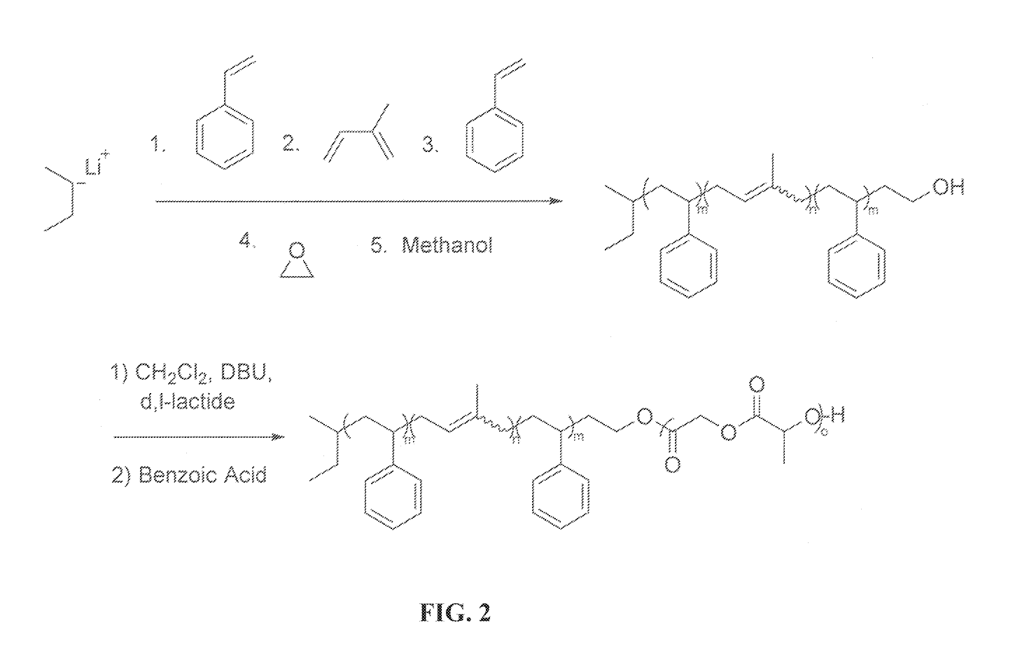

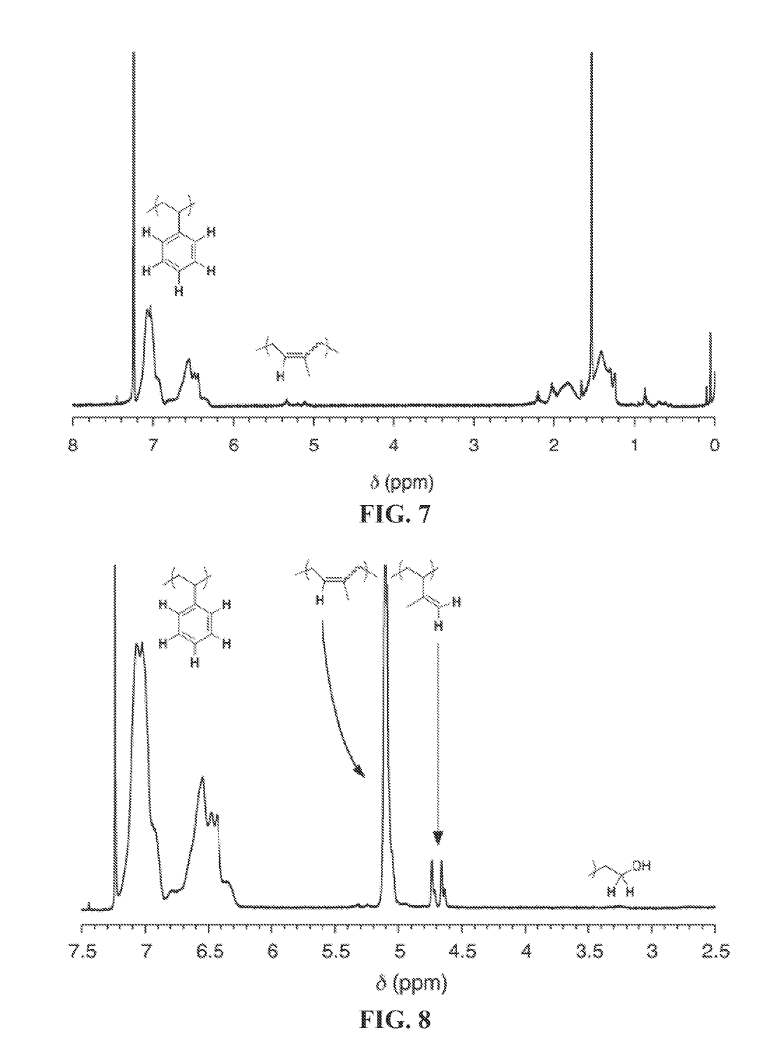

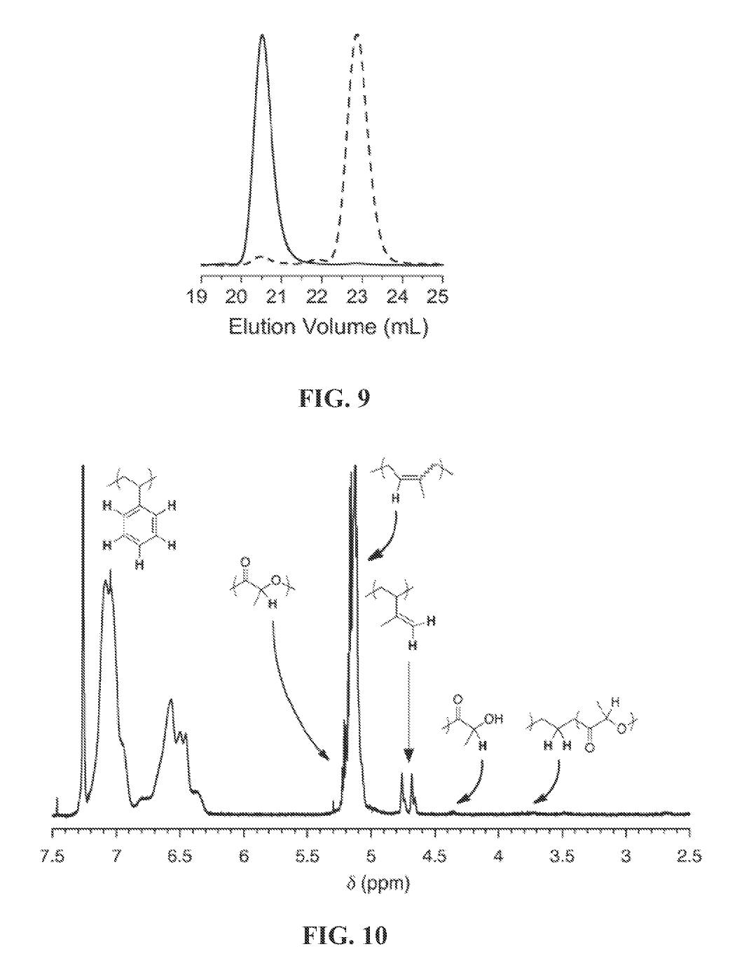

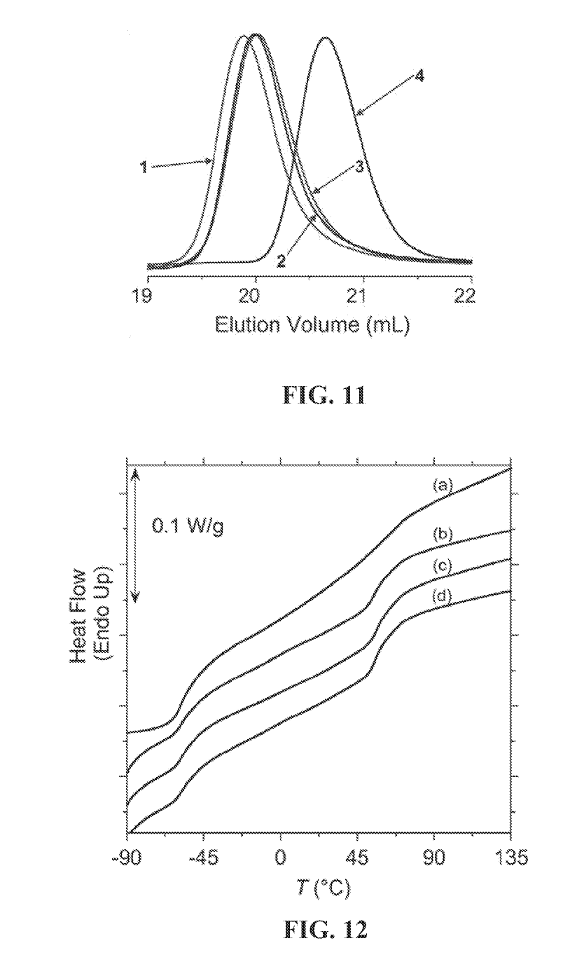

Three PS-PI-PS-PLA tetrablock terpolymers were synthesized by polymerization of d,l-lactide from one parent PS-PI-PS-OH triblock polymer with symmetric composition (f_{PS}=f_{PI}) and PS blocks of approximately equal length synthesized by sequential anionic polymerization according to a previously reported procedure (Bailey, T. S., et al., Macromolecules 2001, 34, 6994-7008). See FIG. 2 for a synthetic scheme. The composition of PS-PI-PS-OH set forth in Table 1 below was determined by a combination of ¹H NMR Spectroscopy (FIG. 7-8) and size-exclusion chromatography (SEC) (FIG. 9). The parent triblock was then used to initiate ring-opening transesterification polymerization (ROTEP) of d,l-lactide catalyzed by 1,8-Diazabicycl[5.4.0]undec-7-ene (DBU). Lohmeijer, B. G. G., et al., Macromolecules 2006, 39, 8574-8583). The PLA molar mass was calculated using ¹H NMR spectroscopy (FIG. 10) as described previously. Bailey, T. S., et al., Macromolecules 2006, 39, 8772-8781. SEC analysis of the PS-PI-PS-PLA samples (FIG. 11) indicated increasing molar mass with increasing PLA content and narrow, monomodal molar mass distributions (Dispersity, [symbol] <1.1 in all cases, see Table 1).

TABLE 1
Molecular characteristics of PS-PI-PS-OH precursor and
PS-PI-PS-PLA polymers

| | | Volume Fraction | | | | | | | | | | |
|---|---|---|---|---|---|---|---|---|---|---|---|---|
| | Mₙ^{a,b} | (f)^{a,b} | | | | D^{c} | | Tg^{d} (° C.) | | | | |
| Sample ID | (kg/mol) | PI | PS | PLA | [symbol] ^{b} | (nm) | Morphology | PI | PS | PLA | ε_{b}^{e} | TS^{f} |
| PS-PI-PS-OH | 20.2 | 0.49 | 0.51 | 0 | 1.04 | 14 | Lam | −58 | 65 | | 370 | 6 |
| PS-PI-PS-PLA(0.20) | 26.9 | 0.39 | 0.41 | 0.20 | 1.06 | 28 | CSC | −57 | 63 | 53 | 370 | 14 |
| PS-PI-PS-PLA(0.21) | 27.4 | 0.39 | 0.40 | 0.21 | 1.09 | 29 | CSC | −57 | 63 | 53 | | |
| PS-PI-PS-PLA(0.25) | 29.1 | 0.37 | 0.38 | 0.25 | 1.10 | 31 | CSC | −57 | 63 | 53 | 450 | 16 |

^{a}Estimated from a combination of ¹H NMR spectroscopy of final PS-PI-PS-OH triblock and size exclusion chromatography on a PS aliquot from the PS-PI-PS-OH synthesis.
^{b}Size exclusion chromatography (RI detector, PS standards, CHCl₃, 35° C.).
^{c}Small-angle X-ray scattering.
^{d}Differential Scanning Calorimetry
^{e}Elongation at break (ε_{b}) determined by Tensile Tests
^{f}Tensile Strength (TS) measured by tensile tests.

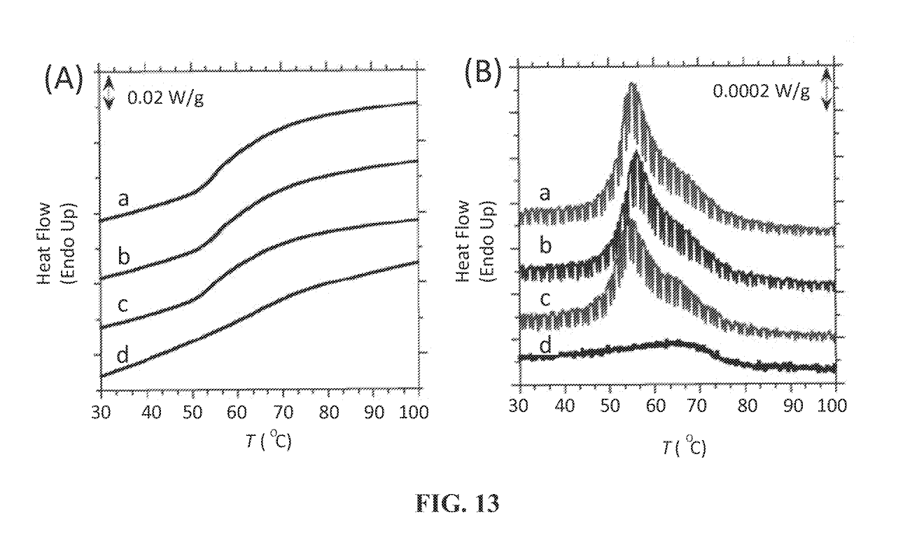

Melt State Phase Behavior: DSC was used to characterize the glass transition temperatures of the PS, PI and PLA blocks (Table 1). Two inflections between 50 and 70° C. are present in the DSC curves of the tetrablocks (FIG. 12-13) suggest that the PS and PLA blocks are microphase separated; Tg, PS (˜63° C.) is approximately 10° C. higher than Tg, PLA (˜53° C.).

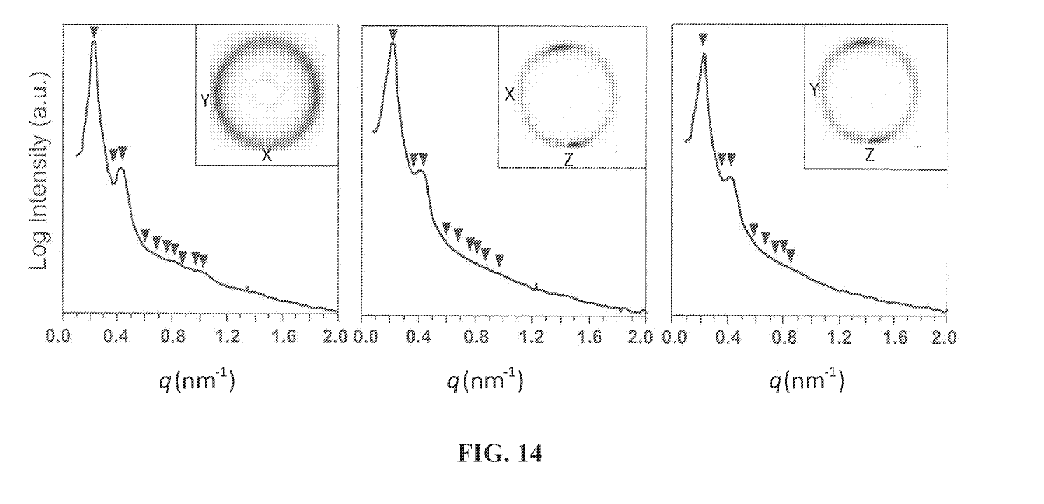

The morphologies formed by the PS-PI-PS and PS-PI-PS-PLA samples listed in Table 1 were determined from a combination of small-angle X-ray scattering (SAXS) data and transmission electron microscopy (TEM) imaging. Powder samples (approximately 400-500 mg) of PS-PI-PS and PS-PI-PS-PLA were pressed into rectangular plaques and then processed using a channel-die at 150° C. to align the underlying morphologies into macroscopically oriented polymer “matchsticks” (stick dimensions W×H×L: 2 mm×2 mm×100 mm). 2D-SAXS was performed on small rectangular pieces (W×H×L: 2 mm×2 mm×5 mm), cut from the end of each sample. All three tetrablock polymers showed similar one-dimensional (1D) and two-dimensional (2D) scattering patterns in the XY, XZ and YZ planes consistent with an aligned hexagonally packed cylindrical morphology (FIGS. 3 and 14). A representative 1D-SAXS profile from the XY plane of channel-die aligned PS-PI-PS-PLA (0.21) reveals a primary scattering peak at q*=0.23 nm⁻¹ (D=27 nm) and higher order reflections that are consistent with hexagonal symmetry (FIG. 3, a).

FIG. 3, a, depicts the 1D-SAXS of PS-PI-PS-PLA polymer (fPLA=0.21) taken at 25° C., after channel-die alignment at 150° C. Triangles indicate theoretical q/q* ratios of 1, √3: √4: √7: √9: √13: √16: √19: and √25 associated with the hexagonal packed cylinder morphology. FIG. 3, b, depicts a cartoon of channel die apparatus showing direction of flow along z-axis. FIG. 3, c, depicts a 2D Morphology characterization of the XY plane (bottom, 2D SAXS pattern; top, TEM of XY face of microtomed channel-die stick). FIG. 3, d, depicts the 2D Morphology characterization of the YZ plane (bottom 2D SAXS pattern; top, TEM of YZ face of microtomed channel-die stick). Scale bar is 100 nm.

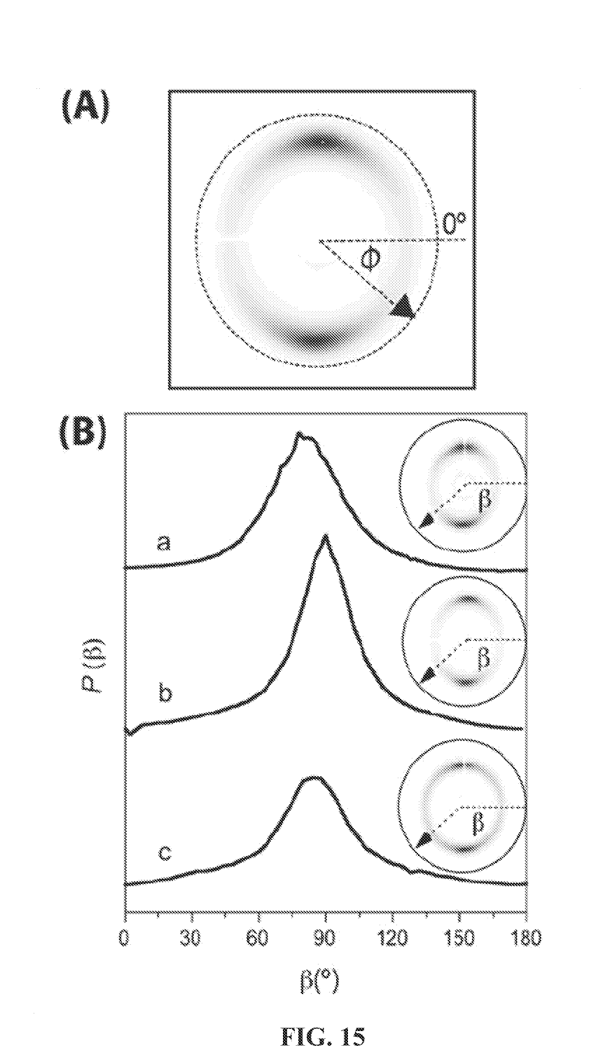

The 2D-scattering (FIG. 3) from each of the three planes (XY, XZ and YZ planes) of PS-PI-PS-PLA (0.21) is consistent with scattering expected from an aligned cylindrical morphology. For a macroscopically aligned cylindrical morphology, incident radiation perpendicular to the direction of flow (i.e., perpendicular to the XZ or YZ planes) produces 2D-SAXS patterns with two distinct peaks in intensity at scattering vectors separated azimuthally by 180° (FIG. 15). Using the 2D-scattering pattern, analysis of the change in the intensity of primary scattering vector, q*, with respect to azimuthal angle β was studied to determine the degree of cylinder alignment. The degree of alignment increases with the value of the second-order orientation factor F₂, from 0 to 1 (i.e., isotropic to perfectly aligned). Values of F₂ between 0.65 and 0.77 were calculated for channel-die aligned PS-PI-PS-PLA tetrablocks indicating that the tetrablocks were mostly aligned in the direction of flow.

Channel-die aligned samples were cryo-microtomed at −100° C. into ˜60-70 nm thick slices and then stained with OsO₄ vapor (10 minutes) prior to TEM imaging to gain contrast between phases. TEM images of a representative channel-die aligned PS-PI-PS-PLA tetrablock (f_{PLA}=0.21) are shown in FIG. 3, c-d. The structure is consistent with an “inverted” cylinder morphology where the majority domains PS and PLA (shown in white) form the cylinders and the minority domain, PI (stained black) forms the matrix. The inverted core-shell cylinder structure of the PS-PI-PS-PLA tetrablocks can be attributed to the A-B-A-C block architecture and the corresponding effect on the sequencing of the segment-segment interaction parameters (χ_{BC}>>χ_{AC}≈χ_{AB}; where A is PS, B is PI and C is PLA).

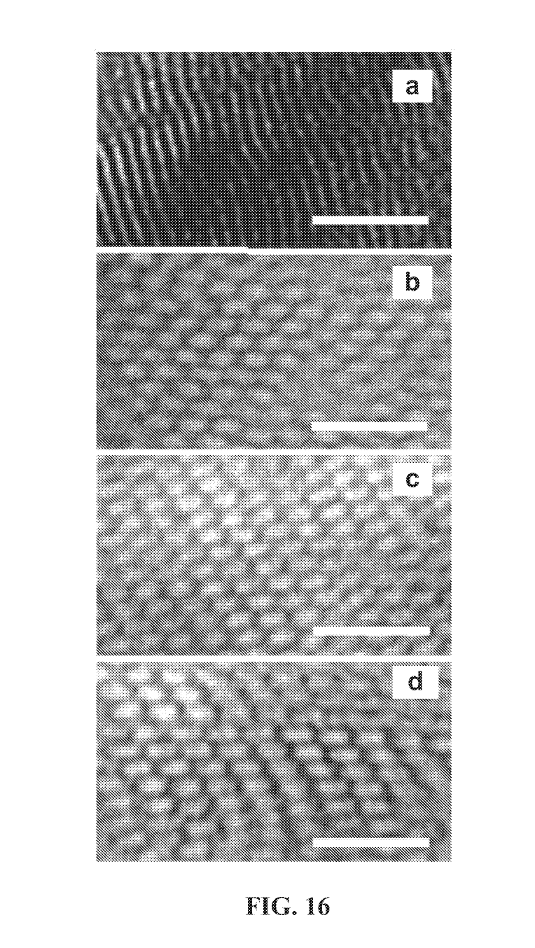

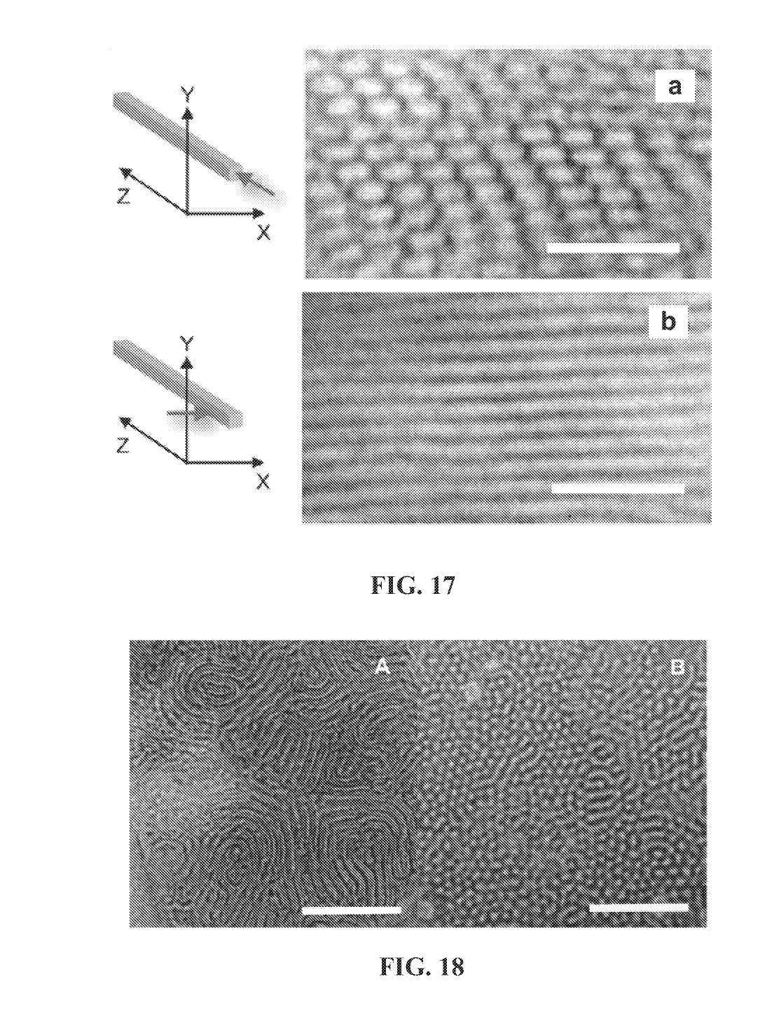

FIG. 3, c, combines a TEM image of the XY plane with a 2-D scattering pattern from the same plane. Imperfect sample alignment during the microtome step resulted in a slight distortion of the hexagonal structure when visualized by TEM. FIG. 3, d, combines both the TEM image and the 2D SAXS pattern for the YZ plane, and both are consistent with an aligned structure. The 1-D scattering data (FIG. 3, a), TEM and 2-D scattering profiles of (FIG. 3, c and d) together point to an aligned hexagonally packed cylinder morphology. This hexagonally packed cylinder morphology is also evident for tetrablocks with f_{PS}=f_{PI} and f_{PLA} between 0.20 and 0.25 (FIG. 16-17).

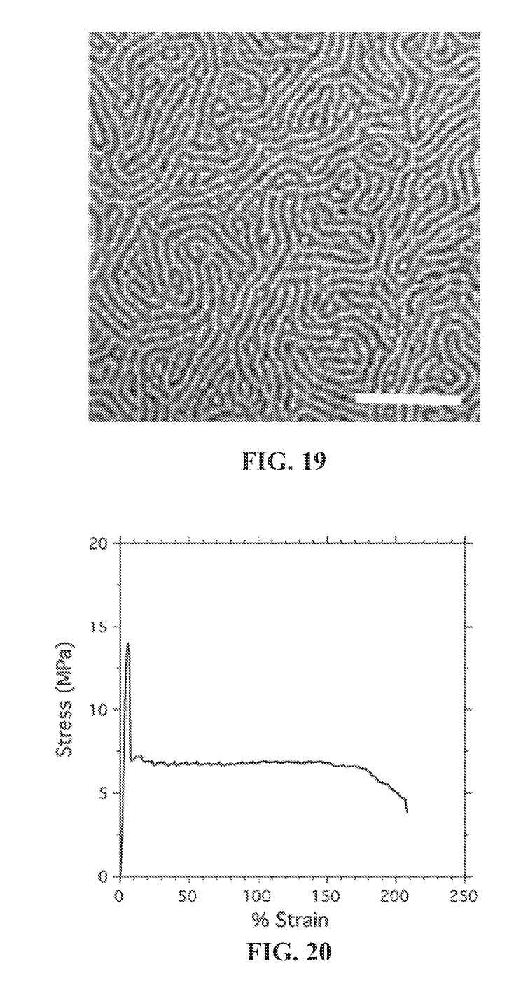

Thin Film Phase Behavior: PS-PI-PS-PLA polymers were drop cast from a dilute solution of toluene (relatively neutral solvent for PS, PI and PLA) onto Formvar™ coated TEM grids and stained with OsO₄. The as-cast specimens also exhibited a cylinder structure of white PS and PLA domains within a dark PI matrix (FIG. 18-19). In these as-cast films, there were regions of parallel cylinder orientation, regions of perpendicular orientation, and also mixed regions (FIG. 19). It is believed that these structures are due to different evaporation rates and film thickness variations across the TEM grid. In some thinner sections of the film (FIG. 18) where the polymer adopts a parallel orientation, contrast between PS (white) and PLA (grey) domains showed the core (PLA)-shell (PS) structure. To further confirm the core-shell cylinder morphology, scanning electron microscopy (SEM) was employed on the PLA etched samples as discussed below.

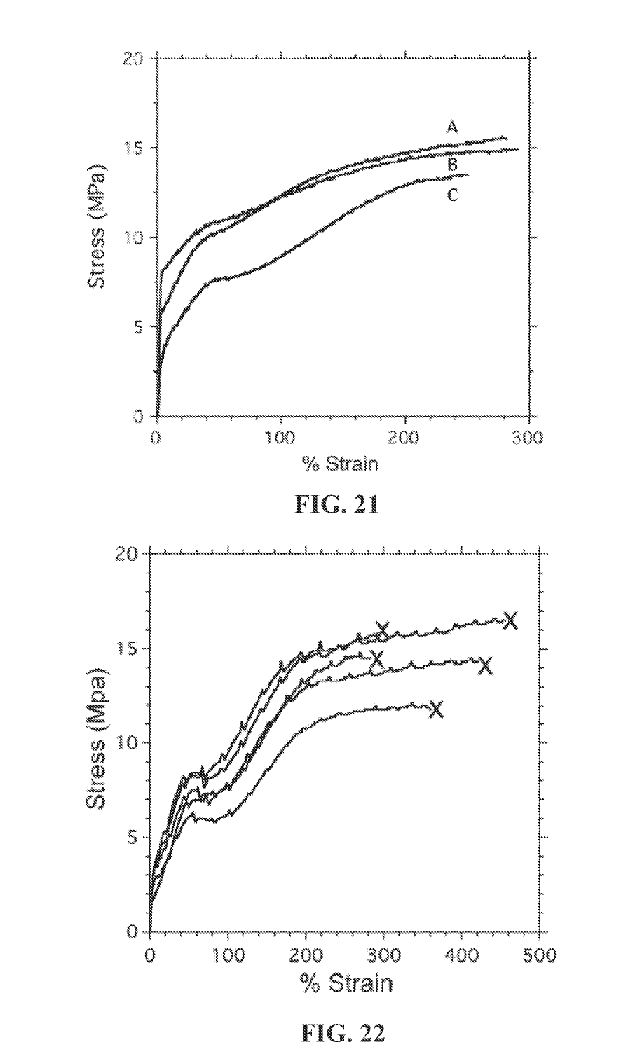

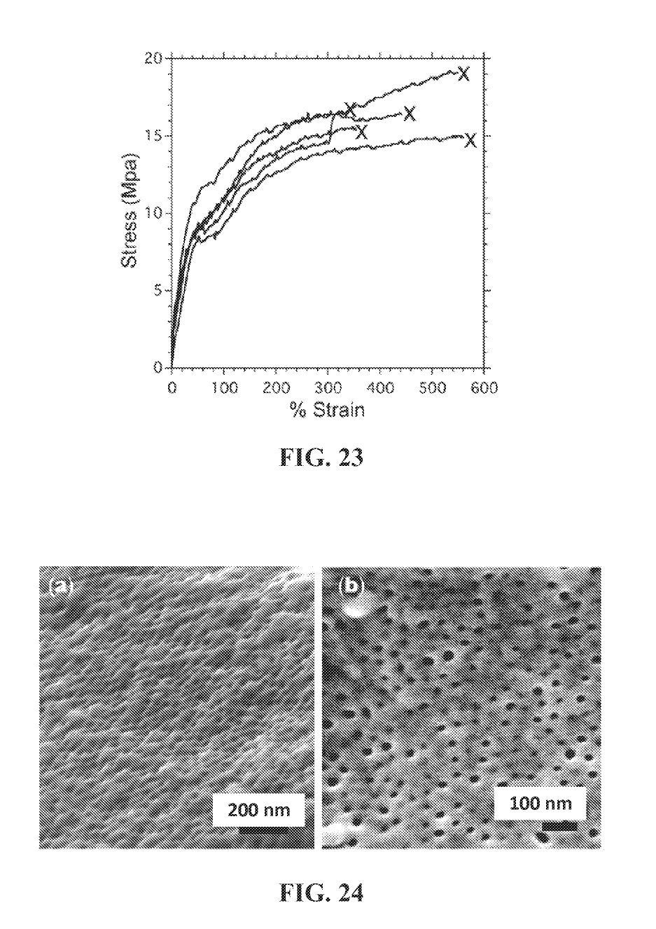

Tensile Properties: Representative engineering stress vs. percent strain curves of PS-PI-PS-PLA (0.20) and PS-PI-PS-PLA (0.25) (FIG. 20-23) demonstrate that these materials consistently behave as tough materials with average elongations at break (ε_{b}) near 450% strain (Table 1). Thus, the nanoporous materials derived from these polymers are believed to be more robust than nanoporous PS or PS-PI-PS monoliths.

Basic hydrolysis of PLA from bulk PS-PI-PS-PLA: PLA was removed by etching with a basic solution (0.5 M NaOH) of 60:40 (v:v) water:methanol at 65° C. To prevent PS pore-wall collapse during the etching of PS-PI-PS-PLA samples, the etching solution temperatures were kept at room temperature because of the relatively low T_{g} of the PS shell (˜63° C.). A small amount of sodium dodecyl sulfate (SDS) was added to increase compatibility between the etching solution and the hydrophobic PS pore walls, ensuring complete infiltration. Initial attempts to remove PLA involved submerging a small cube cut from a channel-die aligned sample into a dilute basic solution (0.5M NaOH, 60:40 (v:v) water:methanol, 0.1 wt % SDS) for one week.

PS-PI-PS-PLA cubes etched at room temperature had visible pores by SEM (FIG. 24) but very limited removal of PLA was effected; SEC and ¹H NMR results suggested that not all of the PLA had been removed from room temperature etched samples. It was suspected that, even with the addition of 0.1 wt % SDS, the hydrophilic etching solution could not reach very far into the pores, likely due to a combination of the hydrophobic nature of the PS-PI-PS matrix imperfect cylinder alignment (alignment 70%). Despite the inability to remove all of the PLA from the bulk samples, it is believed that nanopores could be created in thin films with greater efficacy by etching.

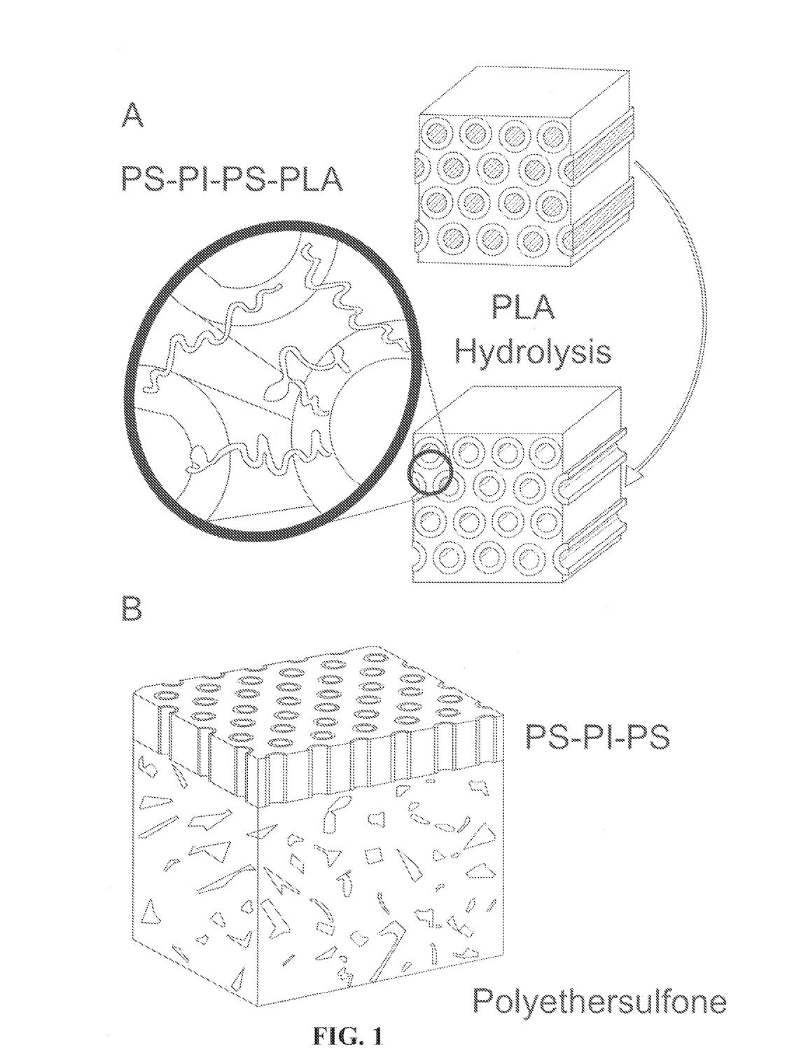

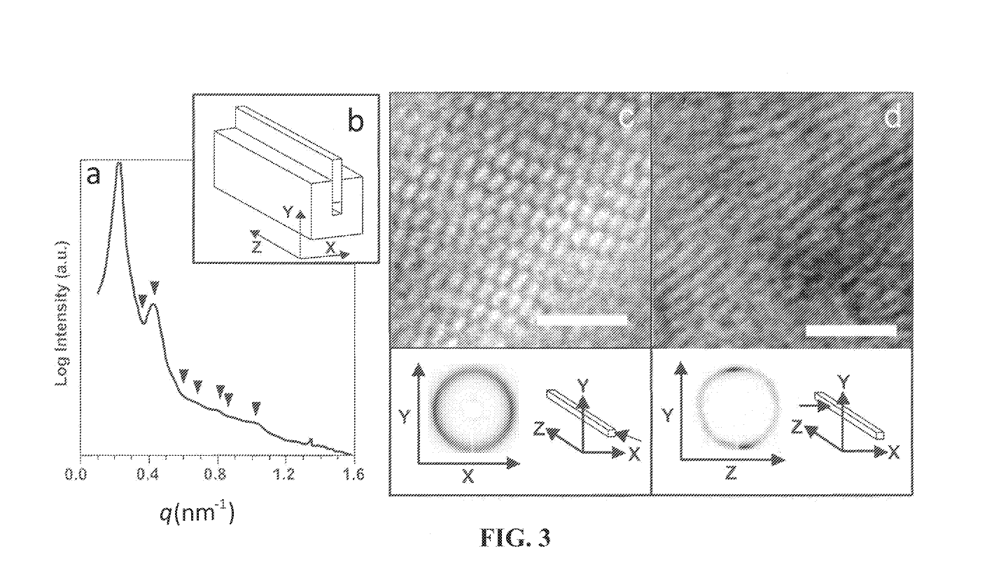

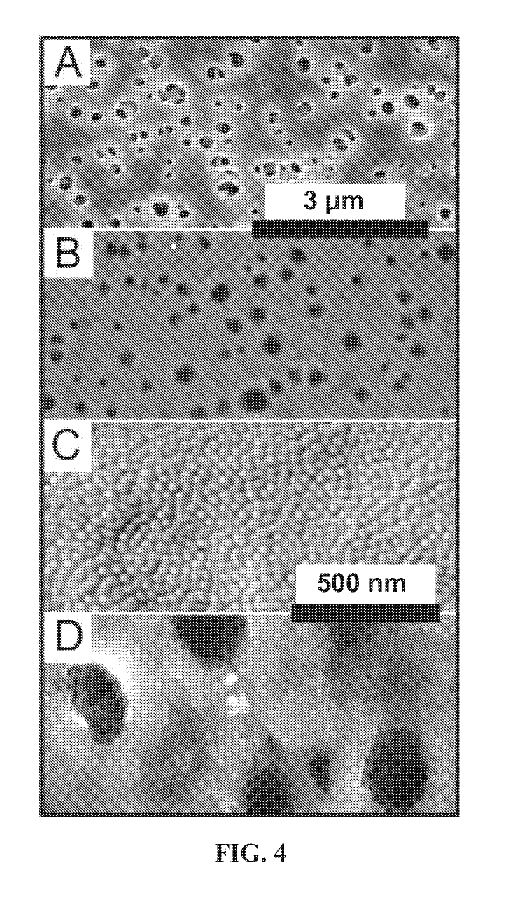

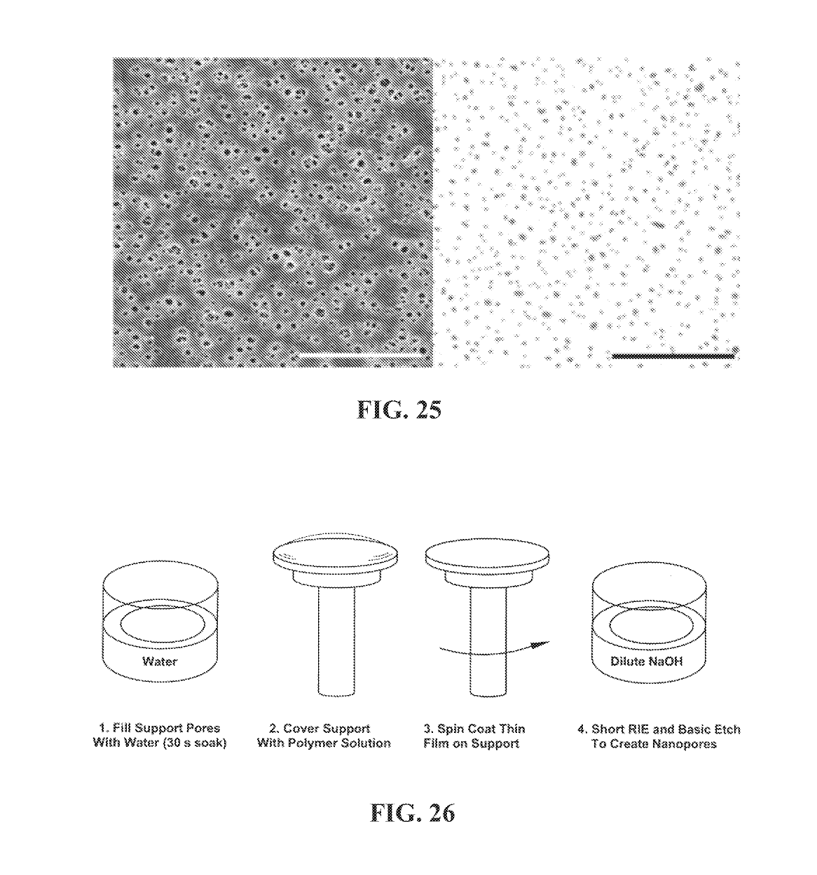

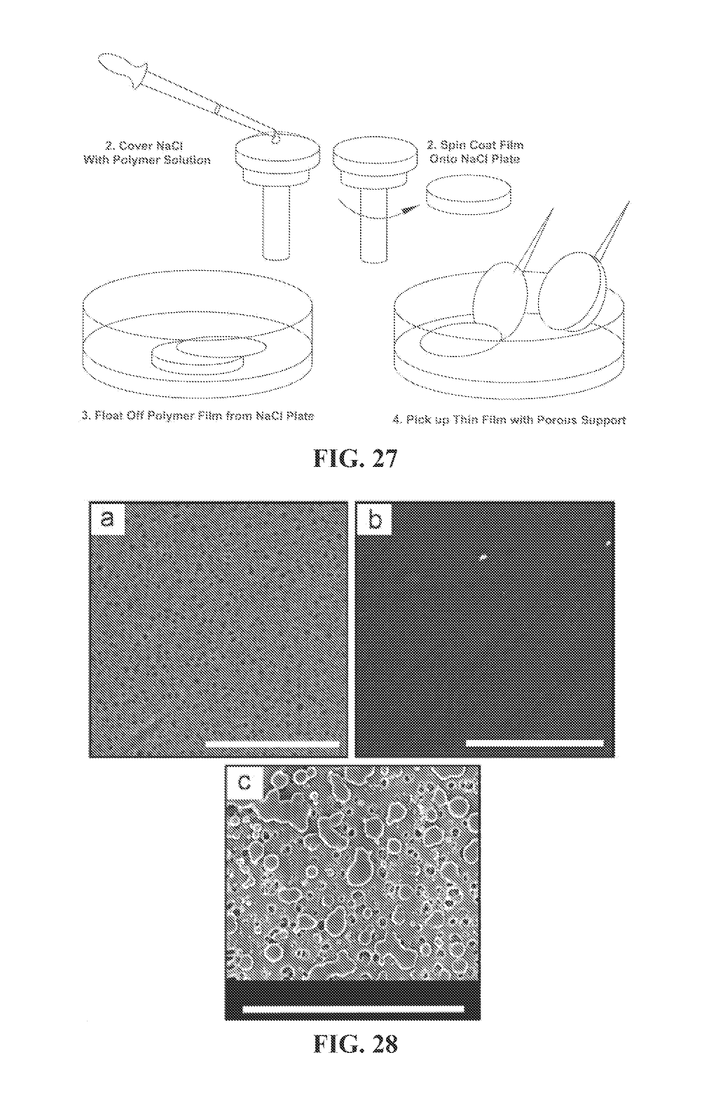

Composite Membranes: FIG. 1 illustrates the structure of the composite membrane prepared above. For the supporting material, a polyethersulfone (PES) membrane (FIG. 4, A) having an average pore diameter of 117 nm±103 nm (from ImageJ analysis of a 133 μm² binarized SEM image (FIG. 25) and a reported molar mass cut-off of 1,000 kDa. Composite membranes were produced by two methods: 1) by directly spin coating the PS-PI-PS-PLA polymer onto a water filled PES support (FIG. 26), Li, X. F., et al., J. Mater. Chem. 2010, 20, 4333-4339; Querelle, S., et al., ACS Applied Materials & Interfaces, 2013, 5, 5044-50 and 2) by spin coating onto a salt plate, dissolving the salt plate and then transferring the film to the PES supporting material (FIG. 27). Yang, S. Y., et al., Adv. Func. Mater. 2008, 18, 1371-1377; Kubo, T.; et al., Appl. Phys. Lett. 2009, 93, 133112(1-3).

To successfully create a fully coated PES support through the direct coating method, it was determined that a right combination of polymer solvent and PES filling liquid was necessary. The combination that resulted in complete coverage of the support and also avoided polymer precipitation during the coating process was to use a non-polar organic solvent with a polar immiscible liquid in the support. Importantly, a filling liquid was needed that would not disturb the block polymer morphology during the coating process and could be washed out easily after coating. Water worked well as a polar filling liquid for the PES support and toluene (FIG. 4, B and FIG. 28, a) or chlorobenzene (FIG. 28, b) as the PS-PI-PS-PLA solvent gave the most complete coverage. The worst coverage was found with water miscible PS-PI-PS-PLA solvents, such as THF (FIG. 28, c).

It was found that it is possible to achieve a uniform, defect-free film by coating the block polymer from chlorobenzene solution. The film surface showed parallel cylinders by AFM for PS-PI-PS-PLA. However, with toluene, a relatively neutral solvent for PS, PI and PLA, it was possible to achieve a mixture of parallel and perpendicular orientation (FIG. 5, a) and also good thin film coverage of the PES support (FIG. 4, b). The dark circular features in FIG. 4, b, are the support pores that are covered with the tetrablock film. These regions are darker than the surrounding surface due to a slight height difference as the tetrablock film sags into the support pores without breaking.

As additional step to the casting procedure, a small amount (5 wt % of total polymer) of PLA homopolymer was added to the PS-PI-PS-PLA solution to induce perpendicular orientation during solvent evaporation in spin coating. A PLA homopolymer with a molar mass of 10 kg mol⁻¹ was chosen because it would be slightly larger than PLA block in the tetrablock polymer (7 kg mol⁻¹). By AFM analysis it was found that compared to the PS-PI-PS-PLA films, films spin-coated from a 95/5 wt/wt PS-PI-PS-PLA (0.21)/PLA blend (2 wt % of polymer overall in toluene; total f_{PLA-Blend}=0.24) contained mostly perpendicularly oriented cylinders at the surface by AFM (FIG. 5b). Thus, addition of homopolymer to block polymer films can be used to tune the pore size of nanoporous block polymer membranes of the invention. As the solvent is removed, confined yet elongated homopolymer chains develop into perpendicular copolymer/homopolymer cylindrical domains with higher regularity than for the copolymer alone.

Using a solution of PS-PI-PS-PLA, PLA and toluene for the film casting process, ordered thin films were prepared as composite membranes. Directly coated composite membranes were prepared by spin coating a 2.3 wt % solution of 95/5 wt/wt PS-PI-PS-PLA/PLA blend in toluene onto water-filled polyethersulfone (PES) membranes (FIG. 4, a). The water filled support was then attached to a spin coater (FIG. 26) and coated with sufficient polymer solution to fully cover the substrate without overflowing the PES surface. Once fully covered with the polymer solution, the PES supports were spun at 2000 rpm and left to dry for at least one hour before removing. Surfaces of resulting membranes after coating are shown in FIG. 4 (b and c).

For composite membranes prepared by the salt plate method (illustrated in detail in FIG. 27), the same toluene solution was dispensed onto a sodium chloride (NaCl) plate and spun at 2000 rpm. After drying, the salt plate was separated from the polymer film by dissolving in water for a few minutes. The resulting thin film was lifted out of the water by scooping up the film from below with the supporting membrane (FIG. 27).

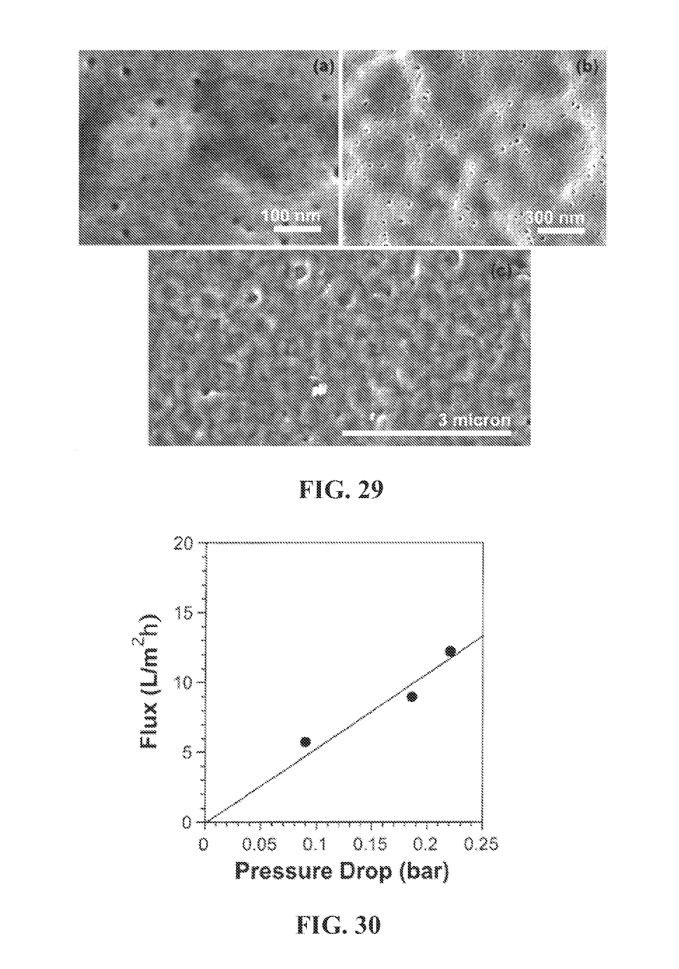

Early attempts to remove PLA by basic hydrolysis without reactive ion etching (RIE) resulted in the formation of only a few nanopores on the surface by SEM. As it was expected that this was due to a surface wetting layer, dried composite membranes were exposed to 15 seconds of reactive ion etching (RIE) to remove any surface wetting layer of PS or PI blocking the PLA domains. After the RIE was carried out, the composite membranes were exposed to a dilute solution of sodium hydroxide in water (0.05 M NaOH) for 45 minutes to hydrolyze and remove the PLA domains. The composite membranes were rinsed with pure water for 20 minutes to remove any residual lactic acid or salts. SEM micrographs of the surfaces of representative composite membranes after RIE and PLA hydrolysis demonstrate the nanopores created through this etching process (FIG. 4, d, directly coated membrane; FIG. 29, for the salt plate method). The support height difference mentioned previously is magnified in FIG. 4, d. The hills and valleys across the film surface made it difficult to image a large area of pores. The average pore size was estimated to be 15 nm from SEM micrographs of the surface of the composite membranes after PLA removal. The pore size estimate was based on the visible nanopores covering the larger support pores. This value is consistent with measurements from other etched PS-PI-PS-PLA/PLA films coated on silicon wafers.

Although clear SEM images were difficult to obtain due to persistent charging of the support membrane, evidence that pores do span the film thickness comes from a combination of the results of SEM study (showing a porous surface), the permeability results of the etched membrane (see below), and the related work showing the presence of pores at the bottom surface of related films prepared on silicon wafers.

### Example 3

This example illustrates some of the properties of the nanoporous membranes in accordance with embodiments of the invention.

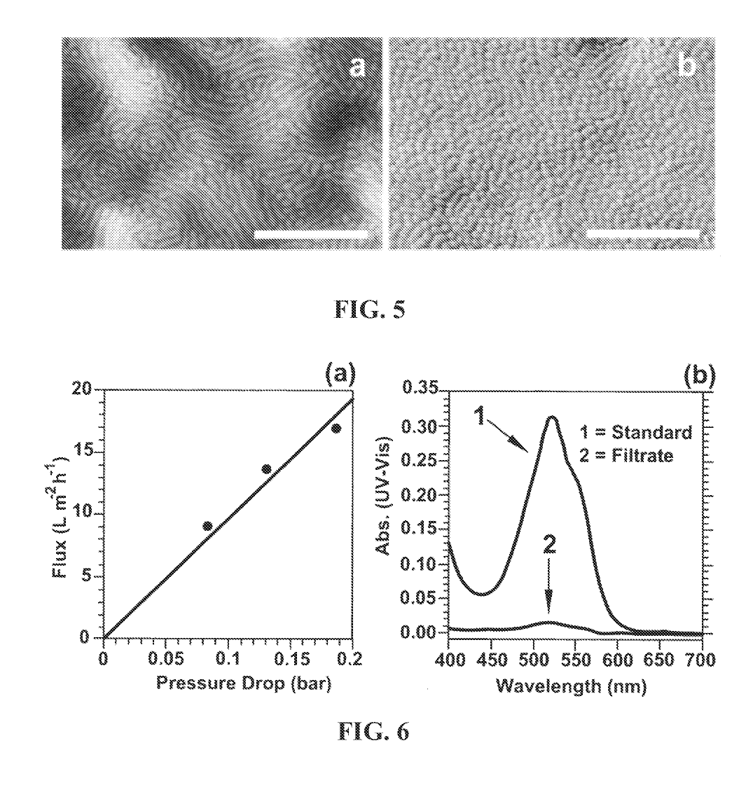

Membrane Evaluation: Results from flow experiments of pure water are shown in FIG. 6. Permeability was measured as 96.9 L m⁻²h⁻¹bar⁻¹ (FIG. 6a) for a membrane prepared by the salt plate method and 53.7 L m⁻²h⁻¹bar⁻¹ for a directly coated membrane (FIG. 30). While the permeability for either membrane is less than expected for the ideal composite membrane of nanoporous PS-PI-PS on the PES support, they are both comparable to commercial ultrafiltration membranes.

The theoretical permeability for an ideal membrane was calculated using the Hagen-Poiseuille fluid flow through a cylindrical pore (Dullien, F. A. L. In Porous media: fluid transport and pore structure; Academic Press: San Diego, 1992; pp 574):

$$v = \frac{ɛ}{τ} ( \frac{{d}^{2} Δ P}{32 μ l} ) \qquad ( 1 )$$

where the fluid velocity, v, is dependent on pore diameter, d, film thickness, l, void fraction, ε, tortuosity, τ, and liquid viscosity, μ. Without the PES support, the ideal permeability for water through the PS-PI-PS selective layer should be 5075 L m⁻²h⁻¹bar⁻¹ using a ε=0.24; l=100 nm; τ=1 (assuming perfect perpendicular cylinder alignment); μ=1×10⁻⁸ bar s (water); and ΔP=1 bar. Accounting for the porosity of the underlying support (0.06, estimated from support surface SEM image by ImageJ analysis of binary image, FIG. 25), it was estimated that the permeability of a composite with an ideal selective layer would be 365 L m⁻²h⁻¹bar⁻¹ assuming no resistance to flow from the underlying support. Assuming that the difference in reduced permeability observed is mostly related to the pore density, the fraction of PLA domains rendered “fully” porous on the surface above the support pores can be equivalent to the ratio of the observed to predicted permeabilities. By this analysis, ˜27% of pores are open for the salt plate method membrane and ˜15% of pores open for the directly coated membrane. From SEM image analysis of the composite membranes after etching, it was estimated that the percent of thin film surface area covered by nanopores at the upper surface is ˜5% for both the salt plate coated and the directly coated films (equivalent to ˜21% of PLA domains open, which falls between the 27 and 15% by permeability estimation).

Considering that the PES support has a measured permeability of 3435 L m⁻²h⁻¹bar⁻¹, it is expected that the composite membrane permeability to be a fraction of that value. If it is assumed that all PLA domains in the above support pores were removed during etching, the resulting pore density on the surface of the membrane should be the PLA fraction of the selective layer (f_{PLA}=0.24) times the void fraction of the support (0.06), or 0.0144 (1.4% of the surface area of the film). If it is simply multiplied by 0.24, the ideal volume fraction of pores in the top layer, by the measured PES permeability, the result is similar, 824 L m⁻²h⁻¹bar⁻¹. This assumes that the block polymer layer is so thin that flux through the length of its pores should have no contribution to the overall permeability. See Phillip, W. A., Block Polymer Membranes for Selective Separations. Ph. D. Dissertation, University of Minnesota, 2009. p. 167. The only contribution that is being considered is the actual surface area of pores in the thin film that connect to the underlying support. Based on SEM image analysis, nanopores cover ˜5% of the thin film surface area for the salt plate films and ˜2.5% of the thin film surface area for directly coated membranes (equivalent to ˜21% and 10.5% of potential pores open, respectively for salt plate and direct coating). This reduction in surface area should bring down the permeability to 172 L m⁻²h⁻¹bar⁻¹ for the salt plate coating and 86 L m⁻²h⁻¹bar⁻¹ for the directly coated membrane if it is assumed that the surface porosity matches the porosity within the thin film layer and that the thickness of the thin film contributes minimal to no resistance to the overall permeability of the composite membrane. These estimations are relatively close to the measured values. SEM imaging after filtration tests confirmed the absence of cracks or defects in the porous film. Furthermore, a Dextran ultrafiltration test also confirmed the lack of membrane defects. Both of these results are consistent with permeability arising solely from the nanopores.

Tetramethylrhodamine-isothiocyanato-dextrans (TRITC-Dex) have been used in biological research mainly for studying permeability and transport in biological tissues and vessels. TdB Consultancy Website. www.tdbcons.se/tdbcons2/attachment/tritc_dextran.pdf (accessed Nov. 20, 2012). They also have been used for accurate UF membrane selectivity characterization. Mulherkar, P. van Reis, R. J. Membr. Sci. 2004, 236, 171-182; Bakhshayeshi, M., et al. J. Membr. Sci. 2011, 379, 239-248. TRITC-Dex was chosen as the solute for the rejection analysis on the present membranes because its concentration could be determined consistently and reproducibly by UV-Vis spectroscopic analysis for concentrations ranging from 0 to 0.5 mg/mL (where TRITC-Dex substitution is 0.001-0.0008 mol TRITC per mol of dextran). Although membrane fouling was not specifically tested for, limited fouling is expected for a neutral TRITC-Dex and a neutral membrane. Mulherkar, P. van Reis, R, supra.

A dilute solution of TRITC-Dex, M_{W}=155 kg/mol, in water (0.5 mg/mL) was prepared and added to the filtration cell. Based on reported sizes, the 155 kg/mol TRITC-Dex should have an hydrodynamic radius (Rₕ) of about 17 nm in diameter when dissolved in water. TdB Consultancy Website. www.tdbcons.se/tdbcons2/attachment/tritc_dextran.pdf (accessed Nov. 20, 2012); Pharmacos Webpage on Dextran Properties. http://www.dextran.net/dextran-physical-properties.html (accessed Nov. 20, 2012).

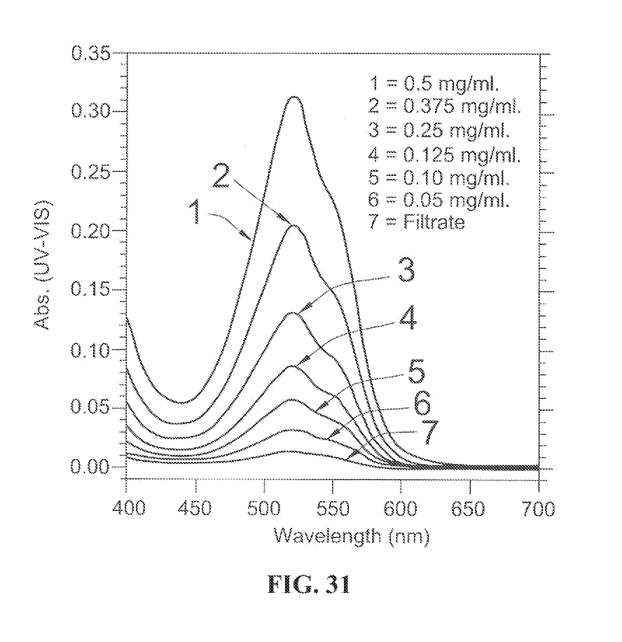

The dextran solution was flushed through the membrane under a pressure of 0.2 bar and a stirring speed of 600 rpm. The filtrate was collected and analyzed by UV-vis to determine dextran concentration. UV-Vis absorption of TRITC-Dex was found at λₘₐₓ=521 nm in the standard solution, consistent with previously reported values for TRITC-Dex in water. Ow, H., et al., U. Nano Lett. 2004, 5, 113-117; Pedone, A., et al., Phys. Chem. Chem. Phys. 2009, 12, 1000-1006. The UV-vis absorptions for the standard solution, pure water and intermediate concentrations of TRITC-Dex in water were also measured for comparison and calibration (FIG. 31). FIG. 6, b, shows the absorption data for the filtrate and standard solution. The pure water flux was measured as the baseline in the experiment. The percent rejection was calculated from the difference between the 0.5 mg mL⁻¹ standard solution peak intensity (pink curve) and the filtrate (blue curve) intensity at λₘₐₓ=521 nm. Samples were analyzed by UV-Vis spectroscopy three separate times and less than 1% difference in absorbance was observed between sets of data. Using this method, an average rejection of 96.9% for the 155 kg mol⁻¹ M_{W} TRITC-Dextran was found. Furthermore, the absorption data for dextran solution that passed through the support alone (FIG. 32) shows no dextran rejection. This indicates that the 96.9% rejection for the composite membrane is solely due to the nanoporous thin film coating.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A porous membrane comprising nanoporous cross-linked poly(styrene)-block-poly(isoprene)-block-poly(styrene).

2. The membrane of claim 1, wherein the nanoporous cross-linked poly(styrene)-block-poly(isoprene)-block-poly(styrene) has a thickness in the range of from about 20 nm to about 500 nm.

3. The membrane of claim 1, comprising a pore diameter of at least about 2 nm.

4. A composite comprising the membrane of claim 1 in combination with a microporous support.

5. The composite of claim 4, wherein the microporous support comprises a microporous membrane.

6. The composite of claim 4, wherein the microporous support comprises a microporous polymeric membrane.

7. The composite of claim 4, wherein the microporous support comprises a sulfone membrane.

8. The composite of claim 7, wherein the sulfone membrane comprises a polyethersulfone membrane.

9. The composite of claim 4, which is prepared by spin coating.

10. The composite of claim 4, which is prepared by a salt-plate transfer/film-transfer process.

11. The membrane of claim 1, wherein the nanoporous cross-linked poly(styrene)-block-poly(isoprene)-block-poly(styrene) is produced by a process comprising providing a poly(styrene)-block-poly(isoprene)-block-poly(styrene)-block-poly(d,l-lactide) tetrablock terpolymer and removing poly(d,l-lactide) from the terpolymer.

12. The membrane of claim 11, wherein the removal of poly(d,l-lactide) is carried out by hydrolysis or by reactive ion etching.

13. The membrane of claim 11, which is produced by a process comprising spin coating poly(styrene)-block-poly(isoprene)-block-poly(styrene)-block-poly(d,l-lactide) tetrablock terpolymer onto a microporous liquid-filled support.

14. The membrane of claim 11, which is produced by a process comprising spin coating poly(styrene)-block-poly(isoprene)-block-poly(styrene)-block-poly(d,l-lactide) tetrablock terpolymer onto a salt plate, dissolving the salt plate, and transferring the tetrablock terpolymer to a microporous support.

15. The membrane of claim 1, wherein the poly(isoprene) block forms a continuous matrix and the poly(styrene) block forms the dispersed phase.

16. The membrane of claim 15, wherein the dispersed phase comprises hollow cylinders.

17. A process for preparing the porous membrane claim 1, comprising reacting a hydroxyl-terminated poly(styrene)-block-poly(isoprene)-block-poly(styrene) block polymer with a d,l-lactide to form a tetrablock copolymer poly(styrene)-block-poly(isoprene)-block-poly(styrene)-poly(d,l-lactide), forming the tetrablock copolymer into a nano-structured thin film having a continuous matrix phase and a dispersed phase, wherein the continuous matrix phase comprises the poly(isoprene) block and the dispersed phase comprises the poly(styrene) block and the poly(d,l-lactide) block, and selectively removing at least a portion of the poly(d,l-lactide) block.

18. The process of claim 17, wherein tetrablock copolymer is dissolved in a solvent and the tetrablock copolymer solution is cast as a nano-structured thin film.

19. The process of claim 18, wherein the tetrablock copolymer solution further contains a poly(d,l-lactide) homopolymer.

20. The process of claim 19, which further includes removing at least a portion of the poly(d,l-lactide) homopolymer from the nano-structured thin film.
